(19) United States
(12) Patent Application Publication
(10) Pub. No.: US 2010/0142767 A1
(43) Pub. Date: Jun. 10, 2010

(54) Image Analysis

(76) Inventor: Alan Duncan Fleming, Aberdeen (GB)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/631,515

(22) Filed: Dec. 4, 2009

Related U.S. Application Data
(60) Provisional application No. 61/119,986, filed on Dec. 4, 2008.

(51) Int. Cl. G06K 9/00

(52) U.S. Cl. 382/117

(57) ABSTRACT

Systems and methods of processing a retinal input image to identify an area representing a predetermined feature. One method comprises processing said retinal input image to generate a plurality of images, each of said plurality of images having been scaled by a respective associated scaling factor, and each of said plurality of images having been subjected to a morphological closing operation with a two-dimensional structuring element arranged to affect the image substantially equally in at least two perpendicular directions. The plurality of images are processed to identify said area representing said predetermined feature.

### FIELD OF INVENTION

The present invention relates to methods and apparatus suitable for use in image analysis. More particularly, but not exclusively, the invention relates to methods for analysing retinal images to determine an indication of likelihood of disease.

### BACKGROUND

Screening of large populations for early detection of indications of disease is common. The retina of the eye can be used to determine indications of disease, in particular diabetic retinopathy and macular degeneration. Screening for diabetic retinopathy is recognised as a cost-effective means of reducing the incidence of blindness in people with diabetes, and screening for macular degeneration is recognised as an effective way of reducing the incidence of blindness in the population more generally.

Diabetic retinopathy occurs as a result of vascular changes in the retina which cause swellings of capillaries known as microaneurysms and leakages of blood into the retina known as blot haemorrhages. Microaneurysms may eventually become a source of leakage of plasma causing thickening of the retina, known as oedema. If such thickening occurs in the macular region, this can cause loss of high quality vision. Retinal thickening is not easily visible in fundus photographs. Fat deposits known as exudates are associated with retinal thickening, and the presence of exudates may therefore be taken to be an indication of retinal thickening. Exudates are reflective and are therefore visible in retinal photographs.

A currently recommended examination technique for diabetic retinal screening uses digital fundus photography of the eye. Fundus images are examined by trained specialists to detect indicators of disease such as exudates, blot haemorrhages and microaneurysms as described above. This is time consuming and expensive.

Automated image analysis may be used to reduce manual workloads in determining properties of images. Image analysis is now used in a variety of different fields. In particular, a variety of image analysis techniques are used to process medical images so as to provide data indicating whether an image includes features indicative of disease. Image analysis techniques for the processing of medical imaging in this way must be reliable both from the point of view of reliably detecting all features which are indicative of disease and from the point of view of not incorrectly detecting features which are not relevant disease.

An image of the retina of the eye has a large number of features including blood vessels, the fovea, and the optic disc. An automated system that is able to distinguish between indicators of disease and normal features of the eye needs to take into account characteristics of the retina so as to properly distinguish features of a healthy eye from features which are indicative of disease. While known systems have been partially successful in identifying features in retinal images, these known systems often fail to sufficiently accurately detect all retinal features of interest. In particular, some known systems often fail to sufficient accurately detect features which are indicative of disease conditions.

### SUMMARY OF INVENTION

It is an object of some embodiments of the present invention to obviate or mitigate at least some of the problems set out above.

According to an embodiment of the invention there is provided a method of processing a retinal input image to identify an area representing a predetermined feature. The method comprises processing said retinal input image to generate a plurality of images, each of said plurality of images having been scaled by a respective associated scaling factor, and each of said plurality of images having been subjected to a morphological closing operation with a two-dimensional structuring element arranged to affect the image substantially equally in at least two perpendicular directions. The plurality of images are processed to identify said area representing said predetermined feature.

The two-dimensional structuring element may have substantially equal extent in two perpendicular directions. The two-dimensional structuring element may be substantially square or substantially circular. For example, the two-dimensional structuring element may have at least four axes of symmetry.

Processing to identify said area representing said predetermined feature may further comprise processing said retinal input image. That is, identification of said area representing said predetermined feature may be based upon both said plurality of images and said retinal input image.

The predetermined feature may be a lesion and the lesion may be a blot haemorrhage.

The method may further comprise processing each of said plurality of images to generate data indicating the presence of linear structures in said plurality of images. The identification of linear structures can improve the identification of said predetermined feature.

Generating data indicating the presence of linear structures in said plurality of images may comprise, for each of said plurality of images, performing a plurality of morphological opening operations with a plurality of linear structuring elements. Each of said linear structuring elements may extend at a respective orientation. For example, the linear structuring elements may be arranged at a plurality of equally spaced orientations which together extend over 360° (or 2π radians).

Processing to identify said area representing said predetermined feature may comprise removing linear structures from each of said plurality of images based upon said data indicating the presence of linear structures. For example, images indicating the location of linear structures may be created, and each of these images can be subtracted from a respective image of the plurality of images to form an image in which linear structures are removed.

Processing said plurality of images to identify said area representing said predetermined feature may comprise combining said plurality of images to generate a single image. The single image may comprise a predetermined number of pixels, and each of said plurality of images may comprise the same predetermined number of pixels. The method may further comprise, for each pixel of said single image, selecting a value for the pixel in said single image based upon values of that pixel in each of said plurality of images.

Processing said plurality of images to identify said area representing said predetermined feature may further comprise performing a thresholding operation using a threshold on said single image. The threshold may be based upon a characteristic of said single image, for example, the threshold may be based upon a distribution of pixel values in the single image.

The method may further comprise identifying a plurality of connected regions of said single image after performance of said thresholding operation. A single pixel may be selected from each of said connected regions, said single pixel being selected based upon a value of said single pixel relative to values of other pixels in a respective connected region.

The method may further comprise processing each of said single pixels to determine a desired region of said single image based upon a respective single pixel. Determining a desired region for a respective pixel may comprise processing said single image with reference to a plurality of thresholds, each of said thresholds being based upon the value of said respective pixel, selecting at least one of said plurality of thresholds, and determining a respective desired region based upon the or each of said selected threshold.

Selecting at least one of said plurality of thresholds may comprise generating data for each of said plurality of thresholds, said data being based upon a property of a region defined based upon said threshold. The property of a region defined based upon said threshold may be based upon a gradient at a boundary of said region. Selecting at least one of said plurality of thresholds may comprise selecting the or each threshold for which said property has a peak value.

Processing said plurality of images to identify said area representing said predetermined feature may comprise generating a plurality of data items, and inputting said plurality of data items into a classifier configured to determine whether an area of said image associated with said plurality of data items represents said predetermined feature. The classifier may be a support vector machine, although any suitable classifier can be used. At least one of the data items may represent a proximity of said area of said image to a further predetermined feature. The further predetermined feature may be an anatomical feature, such as the fovea, the optic disc, or a blood vessel.

A further embodiment of the invention provides a method of processing a retinal image to detect an area representing a blot-haemorrhage. The method comprises locating at least one area considered to be a candidate blot haemorrhage; locating at least one vessel segment extending proximal said at least one area; and determining whether said area represents a blot-haemorrhage based upon at least one property of said at least one vessel segment.

This embodiment of the invention is based upon the surprising realisation that the detection of blot haemorrhages can be made more reliable by taking into account properties of blood vessels extending close to an area which it is considered may represent a blot haemorrhage. In particular, processing arranged to identify discontinuities within blood vessels has been found to be particularly useful when seeking to identify blot haemorrhages which are coincident with a blood vessel, and to allow discrimination between such blot haemorrhages and areas where two vessels cross, but which do not include any blot haemorrhage.

The methods are based not upon detection of blood vessels per se but rather upon a property of a detected blood vessel, examples of suitable properties being set out in the following description.

The at least one property of the at least one vessel segment may be defined with respect to a property of said candidate blot haemorrhage. For example, the at least one property may be based upon a relationship between said candidate blot haemorrhage and a background area and a relationship between said at least one vessel segment and a background area.

Determining said at least one property of the at least one vessel segment may comprise generating first data indicating a first property of said candidate blot haemorrhage, generating second data indicating said first property of each of said at least one vessel segment; and determining a relationship between said first and second data. The first property may be width. The at least one property may comprise an intersection angle between a pair of vessel segments.

Determining whether said area represents a blot-haemorrhage based upon at least one property of said at least one vessel segment may comprise inputting data to a classifier (such as, for example, a support vector machine) arranged to generate data indicating whether said area represents a blot haemorrhage. The classifier may output a data value, and determining whether said area represents a blot haemorrhage may comprise comparing said data value with a threshold value.

In another embodiment of the invention there is provided a method of processing a retinal image to identify a lesion included in the image. The method comprises identifying a linear structure in said image; generating data indicating a confidence that said linear structure is a blood vessel; and processing a candidate lesion to generate data indicating whether said candidate lesion is a true lesion, said processing being at least partially based upon said data indicating a confidence that said linear structure is a blood vessel.

This embodiment of the invention is based upon the realisation that differentiating linear structures included in a retinal image which represent blood vessels from other linear structures can improve the accuracy with which blot haemorrhages are detected. This aspect of the invention can be used to process a candidate blot haemorrhage so as to determine whether the candidate blot haemorrhage is in fact a true blot haemorrhage.

Generating data indicating whether said candidate lesion is a true lesion may comprise inputting said data indicating a confidence that said linear structure is a blood vessel to a classifier. The classifier may output a data value, and determining whether said candidate lesion is a true lesion may comprise comparing said data value with a threshold value.

Generating data indicating a confidence that said linear structure is a blood vessel may comprise inputting a plurality of data values each indicating a characteristic of said linear structure and/or a characteristic of said candidate lesion to a vessel classifier arranged to provide data indicating a likelihood that said linear structure is a blood vessel. The plurality of data values may comprise a data value indicating a parameter relating to width of said linear structure. The parameter relating to width of said linear structure may be a mean width of said linear structure along its length or a variability of width of said linear structure along its length. Such variability may be represented by, for example, a standard deviation.

The plurality of data values may comprise a data value indicating an extent of said candidate lesion. The extent of said candidate lesion may be an extent in a direction substantially perpendicular to a direction in which said linear structure has greatest extent. The plurality of data values may comprise a data value indicating a relationship between a characteristic of said linear structure and a background region. The plurality of data values may comprise a data value indicating a gradient between said linear structure and a background region. The plurality of data values may comprise a data value indicating a location of said linear structure relative to said candidate lesion.

In a further embodiment of the invention there is provided a method of processing a retinal image to detect an area representing a bright spot. The method comprises processing said image to remove linear structures and generate a processed image; and detecting said area representing a bright spot in said processed image.

This embodiment of the invention is based upon the realisation that removing linear structures from a retinal image can improve the accuracy of detection of bright spots such as exudates, drusen and cotton wool spots. Such bright spots are sometimes known as bright lesions.

The method may further comprise processing said retinal image to locate an area representing the optic disc. Location of the optic disc can improve the effectiveness of bright spot detection. In particular, the method may comprise excluding said area representing the optic disc from processing of said retinal image so as to avoid areas of the optic disc incorrectly being determined to be abright spot such as an exudate.

As will become clear from the description set out hereinafter, various of the techniques used in the detection of blot haemorrhages can be applied, with suitable modification, to the detection of bright spots such as exudates.

Processing said processed image to identify said area representing said bright spot may comprise generating a plurality of data items, and inputting said plurality of data items into a classifier configured to determine whether an area of said image associated with said plurality of data items represents a bright spot. The classifier may generate output data indicating one or more confidences selected from the group consisting of: a confidence that said area represents drusen, a confidence that said area represents an exudate, and a confidence that said area represents a background region, and a confidence that said area represents a cotton wool spot.

The classifier may comprise a first sub-classifier arranged to generate data indicating a confidence that said area represents an exudate and a confidence that said area represents drusen, a second sub-classifier arranged to generate data indicating a confidence that said area represents an exudate and a confidence that said area represents a background region, and a third sub-classifier arranged to generate data indicating a confidence that said area represents drusen and a confidence that said area represents a background region.

The classifier may compute a mean of confidence values produced by said first sub-classifier, said second sub-classifier and said third sub-classifier to generate said output data.

The classifier may comprise a plurality of sub-classifiers, each sub-classifier being arranged to generate data indicating a confidence that said area represents each of a respective pair of area types, each of said area types being selected from the group consisting of: drusen, exudate, background and cotton wool spot.

The classifier may compute a mean of confidence values produced by each of said plurality of sub-classifiers to generate said output data.

A further embodiment of the invention provides a method of processing a retinal image to detect an area representing a bright spot, the method comprising processing said retinal input image to generate a plurality of images, each of said plurality of images having been scaled by a respective associated scaling factor, and each of said plurality of images having been subject to a morphological operation.

The morphological operation may be intended to locate a predetermined feature in the retinal image, and thereby improve the detection of an area representing an exudate. The morphological operation may be a morphological opening operation.

Some of the methods described herein are arranged to detect an area of a retinal mage representing a vessel. Such methods may comprise identifying an area considered to represent a lesion; and processing said image to detect a vessel, said processing being carried out only on parts of said image outside said area considered to represent a lesion.

That is, vessels are located only outside areas which are considered to be lesions, thus avoiding incorrect identification of vessels and/or lesions.

An embodiment of the invention also provides methods for processing a retinal image to determine whether the retinal image includes indicators of disease. In particular, it is known that the occurrence of blot haemorrhages and bright spots can be indicative of various disease conditions, and as such methods are provided in which the methods set out above for the identification of bright spots and blot haemorrhages are applied to generate data indicating whether a processed retinal image includes indicators of disease. The processing of retinal images in this way can determine whether the retinal image includes indicators of any relevant disease. In particular, the methods can be used to detect indicators of diabetic retinopathy, age-related macular degeneration cardio-vascular disease, and neurological disorders (for example Alzheimer's disease) although those skilled in the art will realise that the methods described herein can be used to detect indicators of any disease which are present in retinal images.

An embodiment of the invention provides a method of processing a retinal image to detect an area representing an exudate. The method comprises processing said image to remove linear structures and generate a processed image and detecting said area representing an exudate in said processed image.

A further embodiment of the invention provides a method of processing a retinal image to detect an area representing an exudate. The method comprises processing said retinal input image to generate a plurality of images, each of said plurality of images having been scaled by a respective associated scaling factor, and each of said plurality of images having been subject to a morphological operation.

A still further embodiment of the invention provides a method of processing a retinal image to determine whether said image includes indicators of disease. The method comprises locating at least one area representing a bright spot by processing said image to remove linear structures and generate a processed image and detecting said area representing a bright spot in said processed image.

Embodiments of the invention can be implemented in any convenient form. For example computer programs may be provided to carry out the methods described herein. Such computer programs may be carried on appropriate computer readable media which term includes appropriate tangible storage devices (e.g. discs). Aspects of the invention can also be implemented by way of appropriately programmed computers.

### BRIEF DESCRIPTION OF DRAWINGS

Embodiments of the present invention will now be described, by way of example only, with reference to the accompanying drawings, in which:

FIG. 1 is a schematic illustration of a system for analysis of retinal images according to an embodiment of the present invention;

FIG. 1A is a schematic illustration showing a computer of the system of FIG. 1 in further detail;

FIG. 2 is an example of a retinal image suitable for processing using the system of FIG. 1;

FIG. 3 is a further example of a retinal image, showing the location of important anatomical features;

FIG. 4 is a flowchart showing processing carried out to identify features of an eye;

FIG. 5 is a flowchart showing a process for vessel enhancement used in identification of temporal arcades in a retinal image;

FIG. 6 is a flowchart of processing carried out to fit semi-ellipses to the temporal arcades;

FIG. 7 is a schematic illustration of an eye showing areas to be searched to locate the optic disc;

FIG. 8 is a flowchart showing processing carried out to locate the optic disc in a retinal image;

FIG. 9 is a schematic illustration of an eye showing location of the fovea relative to the optic disc;

FIG. 10 is a flowchart showing processing carried out to locate the fovea in a retinal image;

FIG. 11 is a flowchart showing processing carried out to identify blot haemorrhages in a retinal image;

FIG. 12 is a flowchart showing normalisation processing carried out in the processing of FIG. 11;

FIG. 13 is a flow chart showing part of the processing of FIG. 11 intended to identify candidate blot haemorrhages in further detail;

FIG. 14 is a series of retinal images showing application of the processing of FIG. 13;

FIG. 15 is a flowchart showing a region growing process carried out as part of the processing of FIG. 11;

FIG. 16 is a flowchart showing a watershed region growing process carried out as part of the processing of FIG. 11;

FIG. 17 is a flowchart showing a vessel detection process carried out as part of the processing of FIG. 11;

FIGS. 18A and 18B are each a series of images showing application of the processing of FIG. 17;

FIG. 19 is a flowchart showing a process for classification of a candidate region;

FIG. 20 is a flowchart showing processing carried out to identify exudates in a processed image;

FIG. 21 is a flowchart showing part of the processing of FIG. 20 intended to identify candidate exudates in further detail;

FIG. 22 is a flowchart showing processing carried out to classify regions as exudates;

FIG. 23 is a graph showing a plurality of Receiver Operator Characteristic (ROC) curves obtained from results of application of the method of FIG. 11;

FIG. 24 is a graph showing a plurality of ROC curves obtained from results of application of the method FIG. 20; and

FIG. 25 is a schematic illustration of an arrangement in which the methods described herein can be employed.

### DESCRIPTION OF SPECIFIC EMBODIMENTS

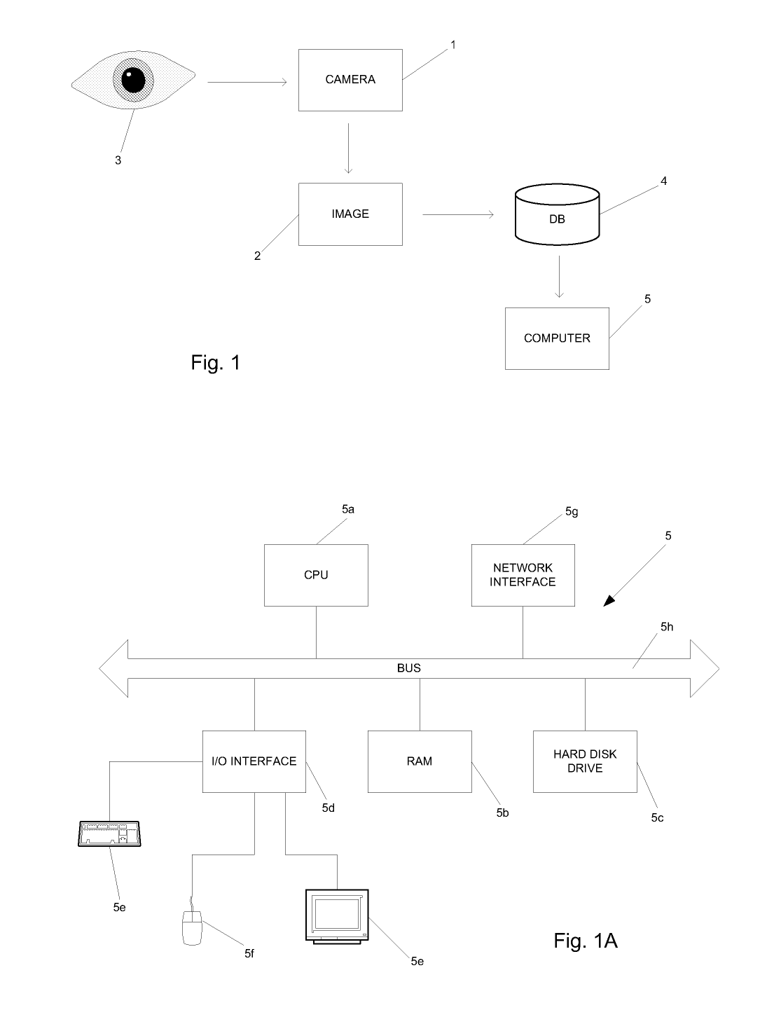

Referring now to FIG. 1, a camera 1 is arranged to capture a digital image 2 of an eye 3. The digital image 2 is a retinal image showing features of the retina of the eye 3. The image 2 is stored in a database 4 for processing by a computer 5. Images such as the image 2 of FIG. 1 may be collected from a population for screening for a disease such as, for example, diabetic retinopathy. The camera 1 may be a fundus camera such as a Canon CR5-45NM from Canon Inc. Medical Equipment Business Group, Kanagawa, Japan, or any camera suitable for capturing an image of an eye.

FIG. 1A shows the computer 5 in further detail. It can be seen that the computer comprises a CPU 5a which is configured to read and execute instructions stored in a volatile memory 5b which takes the form of a random access memory. The volatile memory 5b stores instructions for execution by the CPU 5a and data used by those instructions. For example, in use, the image 2 may be stored in the volatile memory 5b.

The Computer 5 further comprises non-volatile storage in the form of a hard disc drive 5c. The image 2 may be stored on the hard disc rive 5c. The computer 5 further comprises an I/O interface 5d to which are connected peripheral devices used in connection with the computer 5. More particularly, a display 5e is configured so as to display output from the computer 5. The display 5e may, for example, display a representation of the image 2. Additionally, the display 5e may display images generated by processing of the image 2. Input devices are also connected to the I/O interface 5d. Such input devices include a keyboard 5e and a mouse 5f which allow user interaction with the computer 5. A network interface 5g allows the computer 5 to be connected to an appropriate computer network so as to receive and transmit data from and to other computing devices. The CPU 5a, volatile memory 5b, hard disc drive 5c, I/O interface 5d, and network interface 5g, are connected together by a bus 5h.

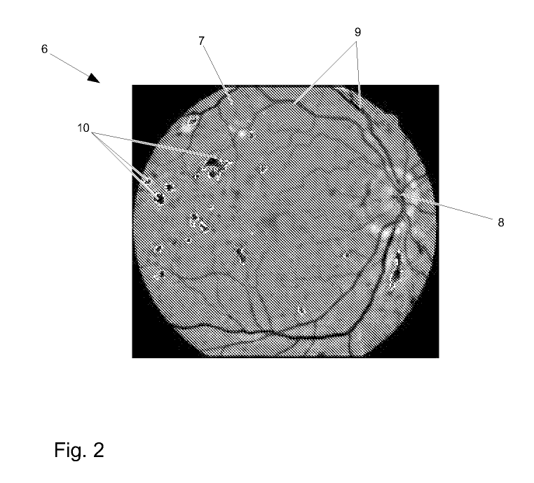

Referring now to FIG. 2, a retinal image 6 suitable for processing by the computer 5 of FIG. 1 is shown. The image 6 shows a retina 7 upon which can be seen an optic disc 8 and blood vessels 9. Further areas 10 can be seen and these further areas can be classified by human inspection. Some of these further areas 10 are indicative of disease and detection and identification of such areas is therefore desirable. Each further area 10 may be, amongst other things, a lesion such as a microaneurysm, a blot haemorrhage, an exudate, drusen, or an anatomical feature such as the optic disc, the macula or the fovea.

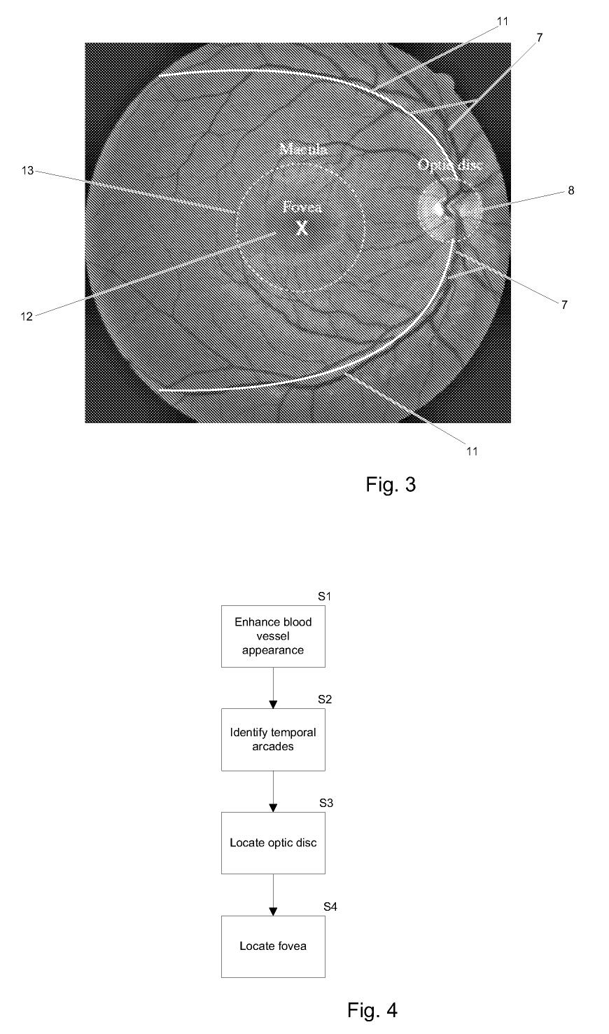

FIG. 3 shows a further image of an eye. FIG. 3 shows the green plane of a colour image, the green plane having been selected because it allows lesions and anatomical features of interest to be seen most clearly. The optic disc 8 can again be seen. The optic disc is the entry point into the eye of the optic nerve and of retinal blood vessels 7. It can be seen that the appearance of the optic disc is quite different from the appearance of other parts of the retina. Retinal blood vessels 7 enter the eye through the optic disc 8 and begin branching. It can be seen that the major blood vessels form generally semi-elliptical paths within the retina, and these paths are known as temporal arcades denoted 11. The fovea 12 is enclosed by the temporal arcades, and is the region of the retina providing highest visual acuity due to the absence of blood vessels and the high density of cone photoreceptors. The fovea appears as a dark region on the surface of the retina, although its location can be masked by the presence of inter-retinal deposits known as drusen, as well as by exudates or cataract. The region surrounding the fovea 12 indicated 13 in FIG. 3 is known as the macula.

The methods described below benefit from accurate location of the optic disc 8 and the fovea 12. This is because areas of an image representing the optic disc 8, the fovea 12 and the macula 13 need to be processed in particular ways. More specifically, artefacts which would normally be considered as indicators of disease are not so considered when they form part of the optic disc. It is therefore important to identify part of a processed image representing the optic disc so as to allow appropriate processing to be carried out. Additionally, it is known that the presence of lesions within the macula 13 has a particular prognostic significance. Furthermore the fovea could be falsely detected as a lesion if it is not identified separately. It is therefore also important to identify part of a processed image representing the fovea 12 and the surrounding macula 13.

Methods for locating the optic disc 8 and fovea 12 in an input image are now described. FIG. 4 shows the processing at a high level. First, at step S1 an input image is processed to enhance the detectability of blood vessels. Then, at step S2, semi-ellipses are fitted to the blood vessels so as to locate the temporal arcades within the image. At step S3 the image is processed to locate the optic disc 8, the processing being limited to an area defined with reference to the temporal arcades 11. At step S4 the image is processed to locate the fovea 12, the processing being limited to an area defined with reference to the temporal arcades 11 and the location of the optic disc 8.

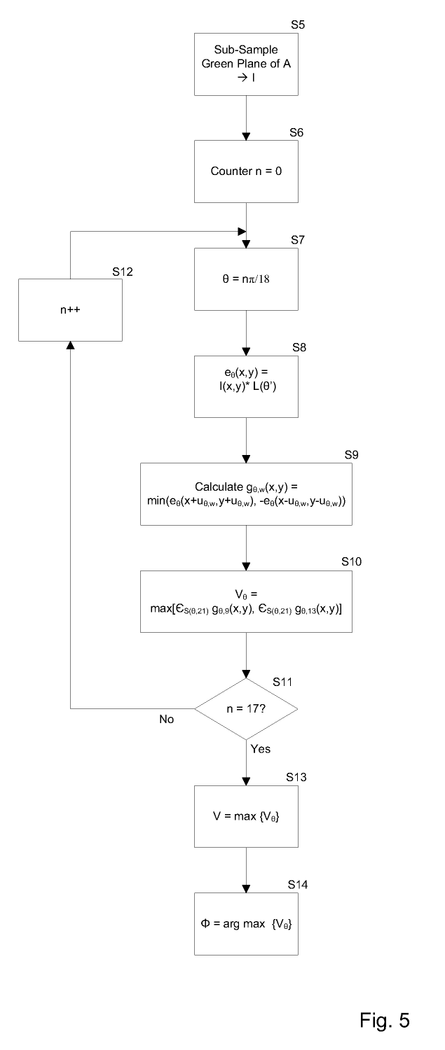

As indicated above, at step S1 an input image is processed so as to enhance the visibility of blood vessels. This aids the location of the temporal arcades at step S2. If the original image is a colour image then the processing to enhance the visibility of blood vessels is carried out using the green colour plane. The process of vessel enhancement is described with reference to a flowchart shown in FIG. 5.

The processing of FIG. 5, as is described in further detail below, is arranged to enhance vessels on the basis of their linear structure. Vessels are detected at a plurality of different angles which are selected such that substantially all vessels can be properly enhanced. Vessels will generally satisfy the following criteria, which are used in the processing of FIG. 5 as is described below:
(i) an intensity gradient will exist at all pixels along each vessel wall;
(ii) intensity gradients across opposite vessel walls will be in approximately opposite directions; and
(iii) vessels are expected to have a range of widths, for example from 5 to 15 pixels depending on the scale of the image.

For improved efficiency, the optic disc and fovea can be detected in images which have been sub-sampled. For example, vessel enhancement does not require an image greater than about 500 pixels per dimension for a 45° retinal image. Different parts of the analysis can be carried out on images which have been subjected to sub-sampling. For this reason, in the following description, dimensions are expressed in terms of the expected optic disc diameter (DD) whose value should be taken to be relevant to the current possibly sub-sampled image. The value 1DD is a standardised disc diameter obtained by taking the mean of, possibly manual, measurements of the diameter of the optic disc in several images.

Referring to FIG. 5, at step S5 the input image is appropriately sub-sampled. An appropriate ration for, sub-sampling may be determined based upon the size of the input image. A counter n is initialised to a value of 0 at step S6. A variable Bis set according to equation (1) at step S7:

$$θ = \frac{n π}{18} \qquad ( 1 )$$

Subsequent processing is arranged to enhance vessels extending at the angle θ. θ′ is an angle perpendicular to the angle θ. That is:

$${θ}^{′} = θ - \frac{π}{2} \qquad ( 2 )$$

A filter kernel L(θ′) is defined by a pixel approximation to a line such that the gradient in direction θ′ can be evaluated, using convolution of the image with this kernel. An example of L(θ′) is:

L(θ′)=[−3,−2,−1,0,1,2,3] (3)

The appropriately sub-sampled green plane of the input image I is convolved with the linear kernel L(θ′) at step S8, as indicated by equation (4):

e_{θ}(x,y)=I(x,y)*L(θ′) (4)

where * denotes convolution.

Given that the linear kernel L(θ′) is arranged to detect edges in a direction θ′, the image e_{θ} indicates the location of edges in the direction θ′ and consequently likely positions of vessel walls extending in the direction θ. As explained above, opposite walls will be indicated by gradients of opposite sign. That is, one wall will appear as a ridge of positive values while the other wall will appear as a ridge of negative values in the image output from equation (4). This is indicated by criterion (ii) above.

An image having pixel values greater than 0 at all pixels which are located centrally between two vessel walls satisfying criterion (ii) is generated at step S9 according to equation (5):

g_{θ,w}(x,y)=min(e_{θ}(x+u_{θ,w}, y+v_{θ,w}),−e_{θ}(x−u_{θ,w},y−v_{θ,w})) (5)

The vector (u_{θ,w}, v_{θ,w}) is of length w/2 and extends in a direction perpendicular to the angle θ. w is selected, as discussed further below to indicate expected vessel width.

It can be seen that a value for a particular pixel (x,y) in the output image is determined by taking the minimum of two values of pixels in the image e_{θ}. A first pixel in the image e_{θ} is selected to be positioned relative to the pixel (x,y) by the vector v_{θ,w},v_{θ,w}) while a second pixel in the image (the value of which is inverted) is positioned relative to the pixel (x,y) by the vector −(u_{θ,w},v_{θ,w}). Equation (5) therefore means that a pixel (x,y) in the output image g has a positive value only if the pixel at (x+u_{θ,w},y+v_{θ,w}) has a positive value and the pixel at (x−u_{θ,w},y−v_{θ,w}) has a negative value. Thus, equation (5) generates a positive value for pixels which are located between two edges, one indicated by positive values and one indicated by negative values, the edges being separated by the value w.

It can be appreciated that the value of w should be selected to be properly indicative of vessel width. No single value of w was found to enhance all vessels of interest. Therefore, applying processing with value of w of 9 and 13 has been found to provide acceptable results.

The preceding processing is generally arranged to identify vessels. However both noise and vessel segments extending at an angle θ will produce positive values in the output image g_{θ}. Noise removal is performed by applying morphological erosion with a linear structuring element s(θ,λ), approximating a straight line of length λ extending at an angle θ, to the output image g_{θ}. After morphological erosion a pixel retains its positive value only if all pixels in a line of length λ extending at the angle θ centered on that pixel also have positive values.

A greater value of λ increases noise removal but reduces the proportion of vessels that are properly enhanced. A value of λ=21 for a 45° image having dimensions of about 500 pixels (or 0.18DD more generally) has been found to give good results in experiments.

Referring again to FIG. 5 it will be recalled that at step S9 an output image g_{θ,w} was formed. At step S10, an output image V_{θ} is created in which each pixel has a value given by the maximum of the corresponding pixels in two images created with different values of w (9 and 13) when eroded with the described structuring element s(θ,λ). This is expressed by equation (6):

V_{θ}=max[ε_{s(θ,21)}g_{θ,9}(x,y),ε_{s(θ,21)}g_{θ,13}(x,y)] (6)

At step S11 a check is carried out to determine whether the value of n is equal to 17, if this is not the case, processing passes to step S12 where the value of n is incremented before processing returns to step S7 and is repeated in the manner described above. In this way, it can be seen that eighteen images V_{θ} are created for different values of θ.

When it is determined at step S11 that processing has been carried out for all values of n which are of interest, processing continues at step S13 where the maximum value of each pixel in all eighteen images V_{θ}, is found so as to provide a value for that pixel in an output image V. At step S14 the angle producing the maximum value at each pixel is determined to produce an output image Φ. That is, the output image Φ indicates the angle θ which resulted in each pixel of the image V having its value.

The processing described with reference to FIG. 5 is arranged to produce an image in which vessels are enhanced. It will be recalled that it is desired to locate the semi-elliptical temporal arcades, as indicated by step S2 of FIG. 4. This is achieved by applying a generalized Hough transform (GHT) to the images V and Φ. Use of the generalized Hough transform is explained in Ballard, D. H.: “Generalizing the Hough transform to detect arbitrary shapes”, Pattern Recognition, 13, 111-122, the contents of which are incorporated herein by reference.

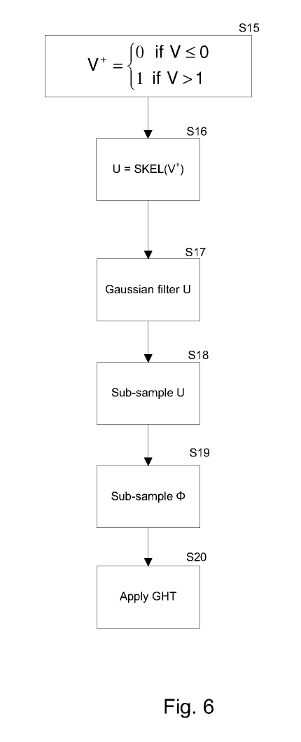

The application of the GHT is shown, at a high level, in FIG. 6.

At step S15 an image V⁺ is formed from the image V according to equation (7):

$${V}^{+} ( x , y ) = \{ \begin{matrix}0 if V ( x , y ) \leq 0 \\ 1 if V ( x , y ) > 0\end{matrix} \qquad ( 7 )$$

The image V⁺ is then skeletonised at step S16 to form an image U. That is:

U=SKEL(V⁺) (8)

To achieve acceptable execution times of the GHT, images V and Φ may need to be greatly sub-sampled. Tests have shown that the GHT performs satisfactorily after U and Φ have been sub-sampled to have each dimension being approximately 50 pixels. At step S17 the image U is Gaussian filtered and at steps S18 and S19 the images U and Φ are appropriately sub-sampled.

At step S20 the GHT is applied to the images U and Φ to locate vessels following semi-elliptical paths.

To enable acceptable execution time and memory usage Hough space is discretized, for example as five dimensions, as follows:
p takes an integer value between 1 and 45 and is an index indicating a combination of ellipse aspect ratio and inclination;
q takes an integer value between 1 and 7 and is an index for a set of horizontal axis lengths linearly spaced from 23.5 to 55 sub-sampled pixels, at the sub-sampled resolution of U′;
h takes an integer value of 1 or 2 and indicates whether the semi-ellipse is the left or right hand part of a full ellipse; and
(a,b) is the location within the image of the centre of the ellipse.

Only some combinations of p and q are useful, given known features of retinal anatomy. For example, combinations of p and q giving rise to an ellipse whose nearest to vertical axis is longer than the anatomical reality of the temporal arcades are discarded.

The use of the GHT to locate the temporal arcades as described above can be made more efficient by the use of templates, as is described in Fleming, A, D,: “Automatic detection of retinal anatomy to assist diabetic retinopathy screening”, Physics in Medicine and Biology, 52 (2007), which is herein incorporated by reference in its entirety. Indeed, others of the techniques described herein for locating anatomical features of interest are also described in this aforementioned publication.

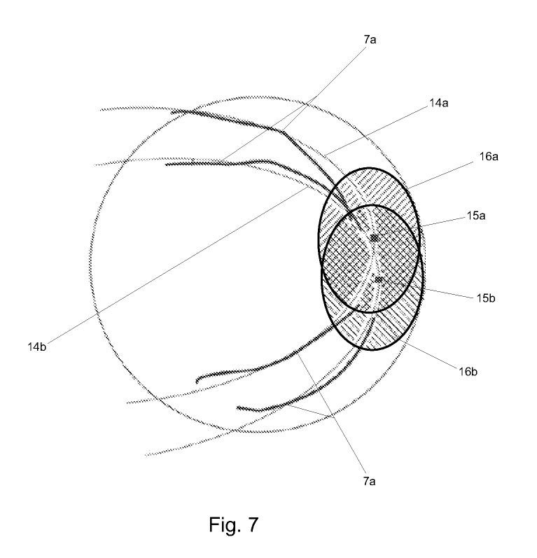

FIG. 7 is a schematic illustration of an eye, showing blood vessels 7a making up the temporal arcades. Two of the semi-ellipses 14 fitted using the processing described above are also shown. The semi-ellipses are used to restrict the search carried out at step S3 of FIG. 4 to locate the optic disc.

Experiments have shown that the optic disc is likely to lie near the right or left most point of the semi-ellipses. Experiments using training images also found that at least one point of vertical tangent of the three semi-ellipses defined in Hough space by (pₙ, qₙ, hₙ, aₙ, bₙ) where n=1,2,3 was close to the position optic disc. The centre of the optic disc usually lies within an ellipse having a vertical height of 2.4DD and a horizontal width of 2.0DD centred on one of these points. Therefore, the union of the ellipses centred the point of vertical tangent of the three ellipses indicated above was used as a search region.

Referring again to FIG. 7, it can be seen that a point 15a on a semi-ellipse 14a has a vertical tangent, as does a point 15b on a semi-ellipse 14b. An ellipse 16a having the experimentally determined dimensions centred on the point 15a is also shown, as is an ellipse 16b centred on the point 15b. The union of the two ellipses (together with a third ellipse not shown in FIG. 7 for the sake of simplicity) defines the area which is to be searched for the location of the optic disc.

A weighting function, W_{oD} is defined to appropriately limit the search area, such that all pixels outside the region of interest defined with reference to the union of ellipses described above have a zero weighting.

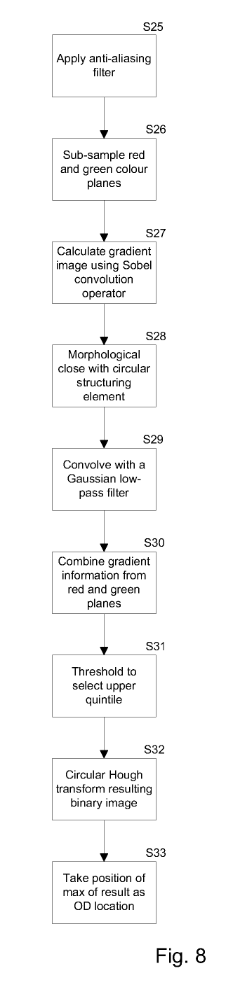

Within the search area, the optic disc is located using a circular form of the Hough transform, as is now described with reference to FIG. 8. Processing efficiency can be improved by sub-sampling the image. First, at step S25 an anti-aliasing filter is applied to the input image. The optic disc is usually most easily detected in the green colour plane of a colour image. However in some cases, detection is easier in the red colour plane, and as such, at step S26 both the green and red colour planes are sub-sampled to give image dimensions of about 250 pixels for a 45° fundus image, so as to improve processing efficiency. Gradient images are then formed by applying a Sobel convolution operator to each of the sub-sampled red and green planes at step S27. In order to remove the influence of vessels in the gradient images, a morphological closing is applied with a circular structuring element having a diameter larger than the width of the largest blood vessels but much smaller than the expected optic disc size at step S28. This morphological closing removes vessels but has little effect on the optic disc because it is usually an isolated bright object. Each gradient image after morphological closing is convolved with a Gaussian low pass filter with σ=1.

At step S30, the filtered gradient images produced at step S29 from each of the red and green colour planes are combined, such that the value of any pixel in the combined image is the maximum value of that pixel in either the two filtered gradient images generated by processing the red and green image planes.

At step S31 a threshold is applied to the image created at step S30 so as to select the upper quintile (20%) of pixels with the greatest gradient magnitude. This threshold removes noise while maintaining pixels at the edge of the optic disc.

A circular Hough transform is applied to the image generated at step S31 so as to locate the optic disc. The variety of radii for the optic disc observed in training images mean that the Hough transform is applied for a variety of radii. More specifically, nine radii arranged in a linear sequence between 0.7DD and 1.25DD were used. Experiments have shown that such radii represent 99% of actual disc diameters experienced. Using local gradient x and y components, the position of the optic disc centre can be estimated for each supposed pixel on the boundary of the optic disc and for each radius value. This means that, for each pixel, only a single Hough space accumulator need be incremented per radius value. Uncertainty in the location and inclination of the optic disc boundary is handled by applying a point spread function to the Hough space, which can be achieved by convolution with a disc of about ⅓ DD in diameter.

The optic disc location is generated at step S33 as the maximum in Hough space from the preceding processing, bearing in mind the limitation of the search area as described above.

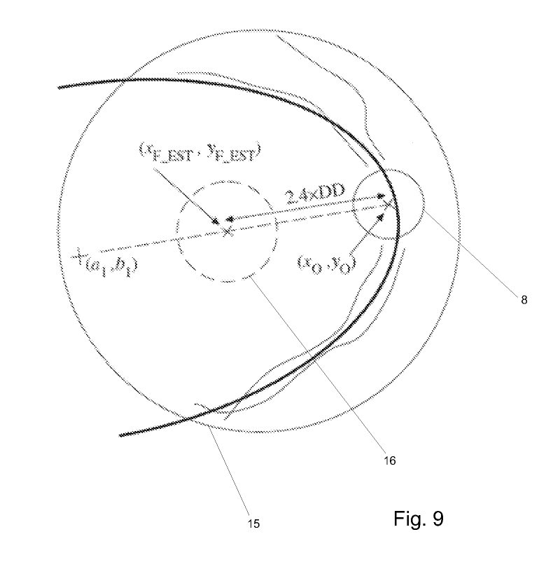

Referring back to FIG. 4, it was explained that at step S4 the image is processed so as to locate the fovea. This is now described in further detail. The process involves locating a point in an input image which is most likely to represent the location of the centre of the fovea based upon a model of expected fovea appearance. The search is limited to a particular part of an input image, as is now described with reference to FIG. 9.

FIG. 9 is a schematic illustration of an eye showing a semi-ellipse 15 fitted using the GHT as described above. The optic disc 8 is also shown, together with its centre (x_{O}, y_{O}) as located using processing described with reference to FIG. 8. The centre of a region to be used as a basis for location of the fovea is indicated (x_{F}_{_{—}}_{EST}, y_{F}_{_{—}}_{EST}). This point is positioned on a line extending from the centre of the optic disc (x_{O}, y_{O}) to the centre of the semi-ellipse having centre (a₁, b₁) as identified using the GHT. The centre of the region to be used as a basis for search is located 2.4DD from the optic disc centre. A circular region 16 expected to contain the fovea has a diameter of 1.6DD. The size of the region expected to contain the fovea, and its location relative to the optic disc were determined empirically using training images.

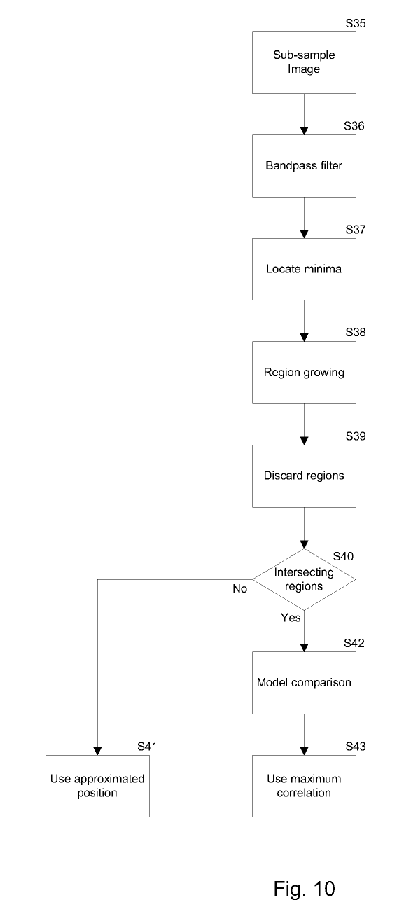

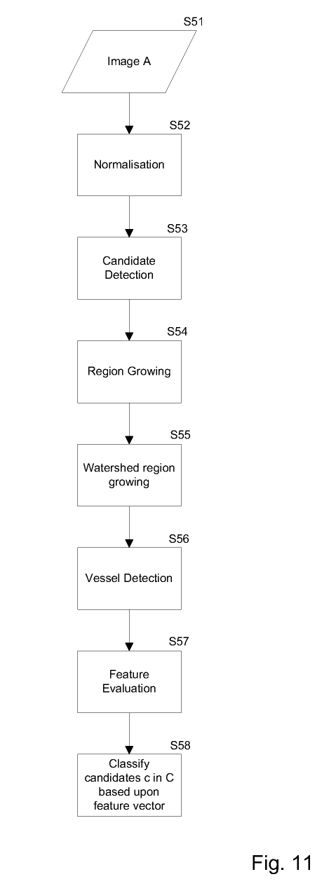

Processing carried out to locate the fovea is now described with reference to FIG. 10. This processing uses the green plane of an image of interest, and the green plane is sub-sampled at an appropriate ratio (down to a dimension of about 250 pixels) at step S35 to produce an image I so as to improve processing efficiency. The sub-sampled image is then bandpass filtered at step S36. The attenuation of low frequencies improves detection by reducing intensity variations caused by uneven illumination and pigmentation. The removal of high frequencies removes small scale intensity variations and noise, which can be detrimental to fovea detection. The filtering is as set out in equation (9):

I_{bpf}=I_{ipf}−I_{ipf}*gauss(0.7DD) (9)

where:
I_{bpf} is the output bandpass filtered image;
gauss(σ) is a two-dimensional Gaussian function with variance σ²;
I_{ipf}=I*gauss(0.15DD); and
I is the sub-sampled green plane of the input image.

At step S37 all local minima in the bandpass filtered image are identified, and intensity based region growing is applied to each minima at step S38. The region generated by the region growing process is the largest possible connected region such that it includes the minimum of interest, and such that all pixels contained in it have an intensity which is less than or equal to a certain threshold. This threshold can be determined for example by taking the mean intensity in a circular region with a diameter of about 0.6DD surrounding the minimum of interest.

Regions having an area of more than about 2.3 times the area of a standard optic disc (i.e. more than 2.3DD) are discarded from further processing on the basis that such areas are too large to be the fovea. Regions which include further identified minima are also discarded.

At step S39 regions which do not intersect the circular region 16 expected to contain the fovea (as described above with reference to page 9) are discarded from further processing. At step S40 a check is carried out to determine whether there are any regions remaining after the discarding of step S39. If this is not the case, the approximated position of the expected position of the fovea relative to the optic disc (x_{F}_{_{—}}_{EST}, y_{F}_{_{—}}_{EST}) is used as the approximate location of the fovea at step S41. Otherwise, processing passes from step S40 to step S42 where regions intersecting the area in which the fovea is expected are compared with a predetermined model of the fovea which approximates the intensity profile of the fovea in good quality training images. The model has a radius R of 0.6DD and is defined as:

M(x,y)=B(A−\sqrt{x²+y²}) (10)

where:
(x, y) E disc(R);
disc(R) is the set of pixels within a circle of radius R centered on the origin; and
A and B are chosen so that the mean and standard deviation of M over disc(R) are 0 and 1 respectively.

The comparison of step S42 is based upon a correlation represented by equation (11):

$$C ( x , y ) = \frac{{\sum }_{( a , b ) ∈ disc ( R )} {I}_{bpf} ( x + a , y + b ) M ( a , b )}{\sqrt{\begin{matrix}{\sum }_{( a , b ) ∈ disc ( R )} {{I}_{bpf} ( x + a , y + b )}^{2} - \\ {\frac{1}{N} [ {\sum }_{( a , b ) ∈ disk ( R )} {I}_{bpf} ( x + a , y + b ) ]}^{2}\end{matrix}}} \qquad ( 11 )$$

Where N is the number of pixels in disc(R) and the mean of C is calculated for all pixels in a particular region.

Having determined a value indicative of the correlation of each region with the model at step S42, processing passes to step S43, where the candidate having the largest calculated value is considered to be the region containing the fovea, and the centroid of that region is used as the centre of the fovea in future analysis.

The preceding description has been concerned with processing images to identify anatomical features. As described above, the identification of such anatomical features can be useful in the processing of images to identify lesions which are indicative of the presence of disease. One such lesion which can be usefully identified is a blot haemorrhage.

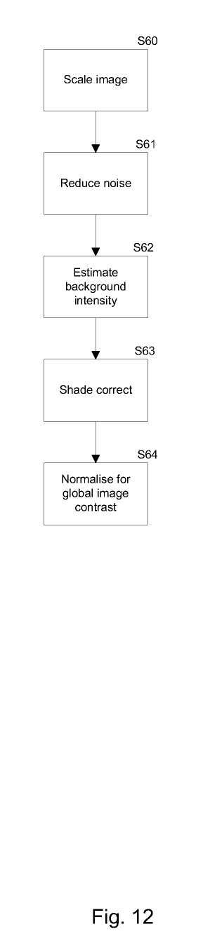

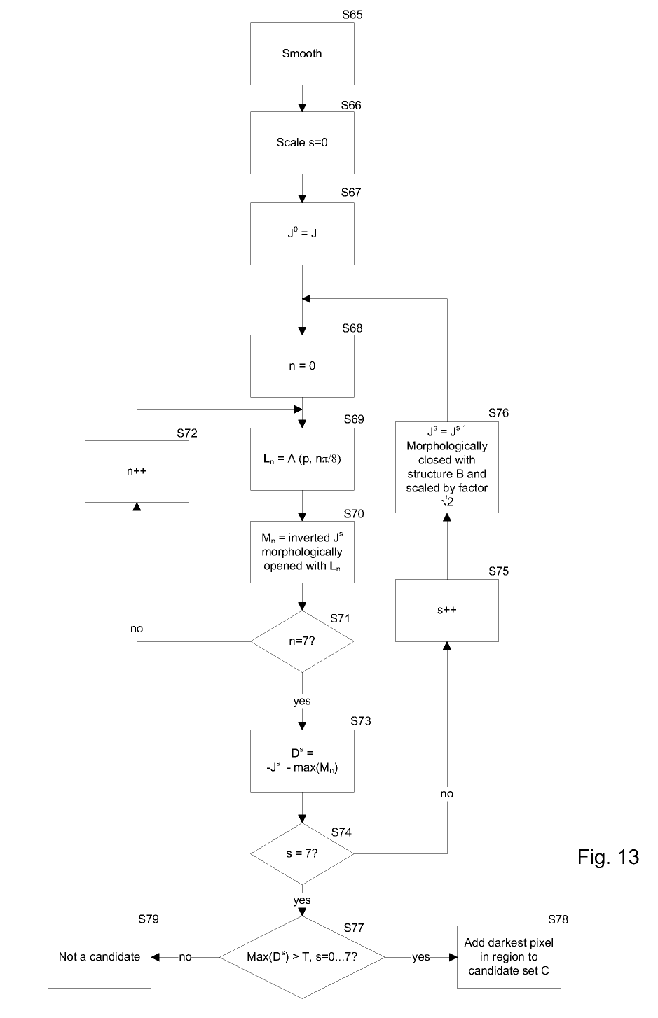

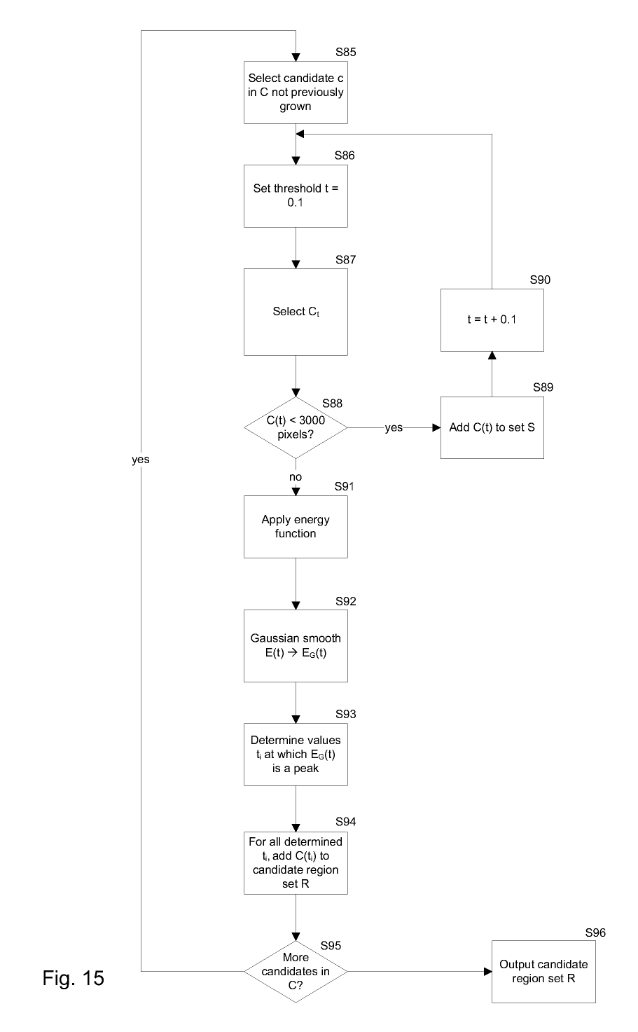

Referring now to FIG. 11, processing to identify blot haemorrhages in an image is shown. At step S51 an image A corresponding to image 2 of FIG. 1 is input to the computer 5 of FIG. 1 for processing. At step S52 the image A is normalised as described in further detail below with reference to FIG. 12 and at step S53 the normalised image is processed to detect points which are to be treated as candidate blot haemorrhages as described in further detail below with reference to FIG. 13. Candidate blot haemorrhages are returned as a single pixel location in the original image A. At step S54 the candidate blot haemorrhage pixels identified at step S53 are subjected to region growing to determine the region of the image A that is a possible blot haemorrhage region corresponding to the identified candidate pixel, as described in further detail below with reference to FIG. 15.

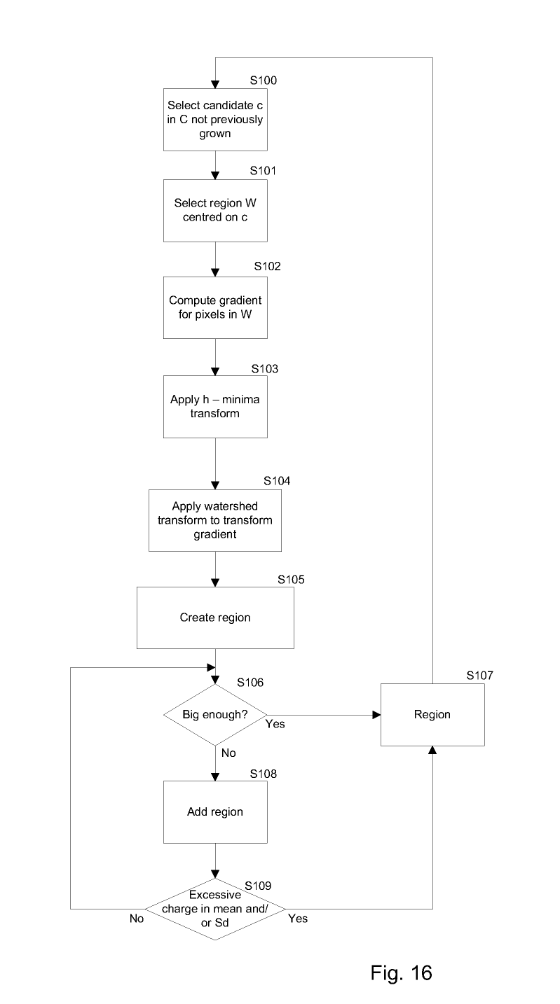

At step S55 a region surrounding the region grown at step S54 is grown (using a technique called “watershed retinal region growing”) such that it can be used in determining properties of the background of the area which is considered to be a candidate blot haemorrhage, as described in further detail below with reference to FIG. 16.

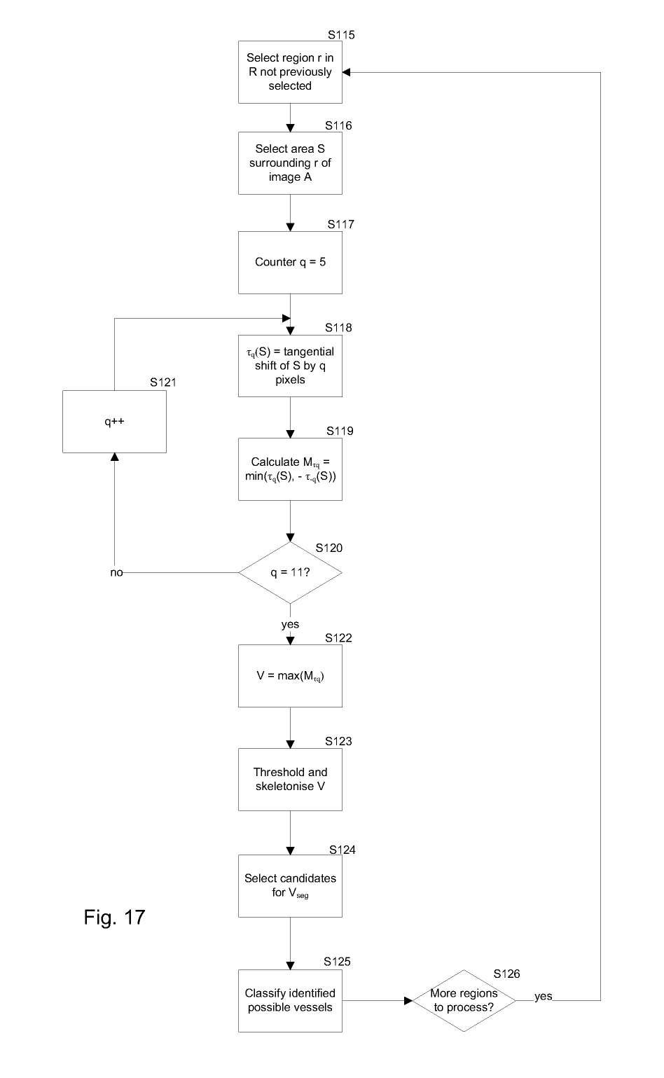

At step S56 a region surrounding each identified candidate region is processed to locate structures which may be blood vessels as described in further detail below with reference to FIG. 17. Areas where vessels, such as blood vessels 9 of FIG. 2, cross can appear as dark regions similar to the dark regions associated with a blot haemorrhage. It is possible to identify areas where vessels cross and this information can be useful in differentiating candidate regions which are blot haemorrhages from other dark regions caused by vessel intersection.

At step S57 each identified candidate blot haemorrhage is processed to generate a feature vector. Features that are evaluated to generate the feature vector include properties of the candidate region together with features determined from the vessel detection of step S56 and the watershed region growing of step S55.

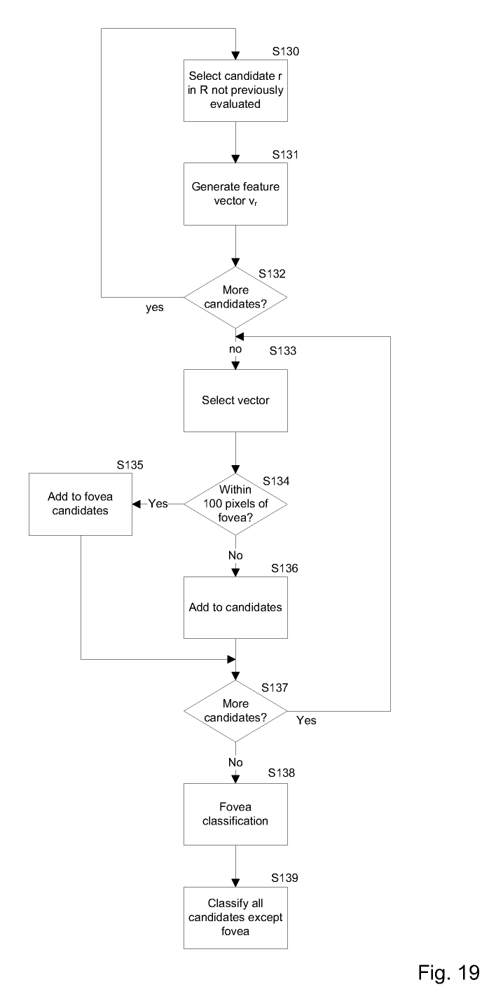

At step S58 each candidate blot haemorrhage is processed with reference to the data of step S57 to determine a likelihood that a candidate is a blot haemorrhage. The determination is based upon the feature vector determined at step S57 together with additional information with regard to the location of the fovea which can be obtained using the processing described above. The processing of steps S57 and S58 are described in further detail below with reference to FIG. 19.

Either one or zero candidates within 100 pixels of the fovea is classified as the fovea and removed from the set of candidate blot haemorrhages. All other candidates are then classified according to a two-class classification that produces a likelihood that each candidate is a blot haemorrhage or background. The two-class classification uses a support vector machine (SVM) trained on a set of hand-classified images.

Referring now to FIG. 12, processing carried out to normalise an image A at step S52 of FIG. 11 is described. At step S60 the original image A is scaled so that the vertical dimension of the visible fundus is approximately 1400 pixels for a 45 degree fundus image. At step S61 the scaled image is filtered to remove noise. The filtering to remove noise comprises first applying a 3×3 median filter, which removes non-linear noise from the input image, and second convolving the median-filtered image with a Gaussian filter with a value of σ=2. An image I is output from the processing of step S61.

At step S62 an image of the background intensity K is estimated by applying a 121*121 median filter to the image A. Applying a median filter of a large size in this way has the effect of smoothing the whole image to form an estimate of the background intensity.

At step S63 a shade-corrected image is generated by pixel-wise dividing the pixels of the noise-reduced image generated at step S61 by the image K generated at step S62 and pixel-wise subtracting 1. That is:

$${J}^{′} ( x , y ) = \frac{I ( x , y )}{K ( x , y )} - 1 \qquad ( 12 )$$

Where I and K are as defined above, and J′ is the output shade-corrected image. Subtracting the value 1 makes the background intensity of the image equal to zero objects darker than the background have negative values and objects brighter than the background have positive values which provides an intuitive representation but is not necessary in terms of the image processing and can be omitted in some embodiments.

At step S64 the resulting image is normalised for global image contrast by dividing the shade-corrected image pixel-wise by the standard deviation of the pixels in the image. That is:

$$J ( x , y ) = \frac{{J}^{′} ( x , y )}{sd ( {J}^{′} )} \qquad ( 13 )$$

FIG. 13 shows the detection of candidate blot haemorrhages at step S53 of FIG. 11. At step S65 the normalised image J output from the processing of FIG. 12 is smoothed by applying an anti-aliasing filter and at step S66 a counter value s is set to 0. The image J is processed at successively increasing scales meaning the size of objects detected at each iteration tends to increase. The scaling can be carried out by reducing the image size by a constant factor such as √2 at each iteration and then applying the same detection procedure at each iteration. The counter value s counts through the scales at which the image J is processed as described below. At each scale, candidate regions are identified which tend to represent larger lesions as the image size is reduced.

At step S67 an image J⁰ representing the un-scaled image is assigned to the input image J. At step S68 a counter variable n is assigned to the value 0 and at step S69 a linear structuring element Lₙ is determined according to equation (14) below:

Lₙ=Λ(p,nπ/8) (14)

where p is the number of pixels in the linear structuring element and Λ is a function that takes a number of pixels p and an angle and returns a linear structure comprising p pixels which extends at the specified angle. It has been found that a value of p=15 is effective in the processing described here.

At step S70 an image Mₙ is determined where Mₙ is the morphological opening of the inverted image J^{s} with the structuring element Lₙ. The morphological opening calculated at step S70 is defined according to equation (15) below,

Mₙ=−J^{s}∘Lₙ (15)

where −J^{s} is the inversion of the image at scale s, Lₙ is the linear structuring element defined in equation (14) and ∘ represents morphological opening.

In the image Mₙ, areas that are possible candidate blot haemorrhages, at the current scale, are removed and areas that correspond to vessels and other linear structures extending approximately at an angle nπ/8 are retained because the morphological opening operator removes structures which are not wholly enclosed by the structuring element. Since a linear structuring element is used, this means structures in the image that are not linear are removed, thus resulting in the removal of areas which are dark in J excluding vessel structures approximately at angle nπ/8 but including the removal of candidate blot haemorrhages.

At step S71 it is determined if n is equal to 7. If n is not equal to 7 then at step S72 n is incremented and processing continues at step S69. If it is determined at step S71 that n is equal to 7 then processing continues at step S73 as described below.

The processing of steps S69 to S72 creates eight structuring elements which are arranged at eight equally spaced orientations. Applying these eight structuring elements to the image −J^{s} creates eight morphologically opened images, Mₙ, each image only including vessels extending at a particular orientation, the orientation being dependent upon the value of n. Therefore, the pixel-wise maximum of Mₙ n=0 . . . 7 includes vessels at all orientations.

At step S73 an image D^{s} is generated by subtracting pixel-wise the maximum corresponding pixel across the set of images Mₙ, for n in the range 0 to 7, from the inverted image −J^{s}. Given that each of the images Mₙ contains only linear structures extending in a direction close to one of the eight orientations nπ/8, it can be seen that the subtraction results in the removal from the image of all linear structures extending close to one of the eight orientations which is generally equivalent to removing linear structures at any orientation. This means that the image D^{s} is an enhancement of dark dots, at the current scale s, present in the original image with vessels removed and candidate blot haemorrhages retained.

As indicated above, an input image is processed at a variety of different scales. Eight scales are used in the described embodiment. The counter s counts through the different scales. At step S74 it is determined if s is equal to 7. If it is determined that s is not equal to 7 then there are further scales of the image to be processed and at step S75 the counter s is incremented.

At step S76 an image J^{s} is determined by morphologically closing the image J^{s-1} with a 3×3 structuring element B and resizing this image using a scaling factor, √2. The structuring element may be a square or approximately circular element and applying the element in this way eliminates dark areas which have at least one dimension with small extent. In particular, closing by the structuring element B removes or reduces the contrast of vessels in the image whose width is narrow compared to the size of the structuring element. Reducing the contrast of vessels can reduce the number of erroneously detected candidate blot haemorrhages. Closing by structuring element B, at each iteration, is particularly important when the morphological processing, at step S73, which distinguishes blot like objects from linear vessels, is applied at multiple scales. This is because when processing is carried out to identify large lesions, and the image is much reduced in size, the linear structuring element no longer fits within the scaled vessels, and as such large lesions are more easily detected.

The processing of steps S68 to S76 is then repeated with the image as scaled at step S78. The scaling function therefore reduces the size of the image so that each time the image is scaled larger candidates are detected, the scaling being applied to the closure of the image processed at the previous iteration.

The scaling and morphological closure with the structuring element B of step S76 can be defined mathematically by equation (16):

J^{s}(x,y)=[J^{s-1}•B](\sqrt{2}x, \sqrt{2}y) (16)

where • is morphological closure.

If it is determined at step S74 that s is equal to 7 then at step S77 candidate blot haemorrhages are determined by taking the maximum pixel value of the images Ds for s in the range 0 to 7 for each pixel of the image and determining if the resulting maximum value for a particular pixel is above an empirically determined threshold T to determine whether that pixel is to be considered to be a blot haemorrhage. A suitable value for T is 2.75 times the 90^{th} percentile of the maxima.

At step S78 a candidate haemorrhage is determined for each connected region consisting entirely of pixels having pixel value greater than T. For each of these regions, the pixels contained within the region are searched for the pixel which is darkest in the shade-corrected image J. At step S78 the darkest pixel in the region is added to a set of candidates C. A pixel taken to indicate candidate haemorrhage is thus selected for each of the regions. For each pixel that it is determined at step S77 that the maximum pixel value of the images D^{s} has a value less than T, at step S79 the pixel is determined to not be a candidate.

Some example images showing stages in the processing of FIG. 13 will now be described.

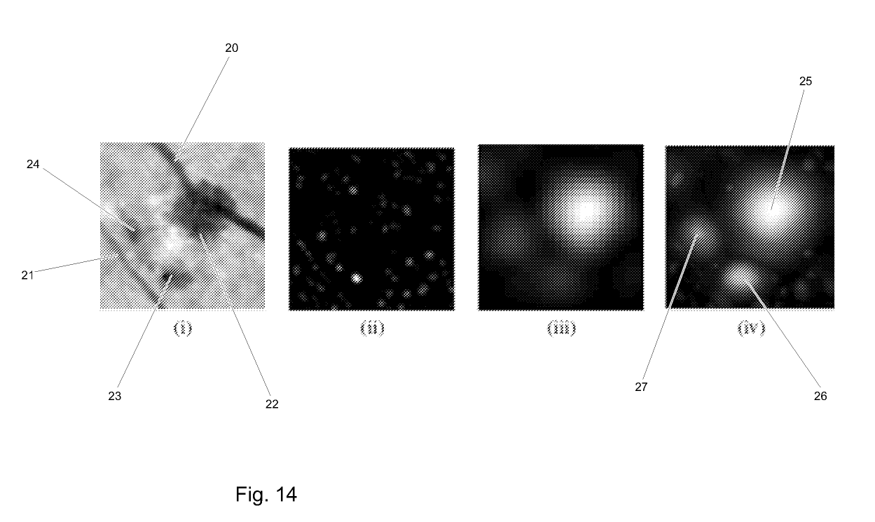

Referring to FIG. 14, five stages of processing a particular image according to FIG. 5 are shown. Image (i) shows the original image portion which contains vessels 20, 21 and large dark areas 22, 23, 24. It is desired to identify the large regions as candidate blot haemorrhages and to not identify the vessels as candidate blot haemorrhages.

Image (ii) shows an image D¹ created using the processing described above. The image area shown in the Image (ii) is the same as that of the Image (i). D¹ is the image processed at the smallest scale and it can be seen that only small regions have been identified.

Image (iii) shows the image −J⁸, that is the image at the largest scale after scaling and morphological closing with the structuring element B, and after inversion (as can be seen by the dark areas appearing bright and the relatively bright background showing as dark). At this largest scale (s equal to 8) only the largest dark area of the original image appears bright.

Image (iv) shows the result of combining D^{s} for all values of s and is the image to which thresholding is applied at step S79. It can be seen in the image (iv) that three areas 25, 26, 27 appear bright that correspond to the dark areas 22, 23, 24.

The darkest pixels in the areas of the original image corresponding to bright areas such as areas 25, 26, 27 are added to a candidate set C. Region growing to identify the region of the original image is then performed from these candidates, and will now be described with reference to FIG. 15.

Referring to FIG. 15, at step S85 a candidate c is selected from the candidate set C that has not previously been selected. At step S86 a threshold t is set to a value of 0.1. At step S87 a region Cₜ of the original image is determined such that Cₜ is the largest connected region (defined in a particular embodiment using orthogonal and diagonal adjacency) containing c and satisfying equation (18) shown below:

J(p)≦J(c)+t, ∀pεCₜ (18)

where J is the normalised original image determined at step S52 of FIG. 11 and J(p) is pixel p of image J.

The area Cₜ determined according to the inequality of equation (18) is a collection of connected pixels of the original image in which each pixel in the area is less dark than the darkest pixel by no more than the value t.

At step S88 it is determined if the number of pixels in the area Cₜ is less than 3000 pixels. If it is determined that the number of pixels is less than 3000 in the area Cₜ then at step S89 area Cₜ is added to a set S and at step S90 the threshold t is increased by a value of 0.1. Processing then continues at step S86 as described above.

The loop of steps S86 to S90 identifies a plurality of increasingly large regions of pixels that are relatively dark when compared to the pixels that lie on the outside of the selected region. Each time the threshold t is increased, pixels that are connected to the region containing the seed pixel c that are less dark than allowed into the region by the previous value of t are included in the area Cₜ. If it is determined at step S88 that the number of pixels that are in the region determined by the threshold t is greater than 3000 then it is determined that the area allowed by the threshold t is too large and processing continues at step S91.

At step S91 an energy function is used to determine an energy associated with a particular threshold t:

E(t)=mean_{pεboundary(C}_{ₜ}₎└grad(p)²┘ (19)

### Where:

boundary (CO is the set of pixels on the boundary of the region Cₜ; and
grad(p) is the gradient magnitude of the normalised original image at a pixel p.

It can therefore be seen that the energy for a particular threshold t is the mean of the square of the gradient of those pixels that lie on the boundary of the region Cₜ. The processing of step S91 produces an energy value for each threshold value t that was determined to result in a region Cₜ containing less than 3000 pixels, i.e. an energy value for each threshold resulting in a region Cₜ being added to the sets at step S89.

At step S92 the values of E(t) are Gaussian smoothed which produces a smoothed plot of the values of energy values E(t) against threshold values t. A suitable value for the Gaussian smoothing function is 0.2, although any suitable value could be used.

At step S93 the values of t at which the Gaussian smoothed plot of the values of E(t) produce a peak are determined and at step S94 the areas Cₜ (referred to as regions r) for values of t for which the smoothed plot of E(t) produces a peak are added to a candidate region set R. Values of t at which E(t) is a peak are likely to be where the boundary of Cₜ separates a blot haemorrhage from its background as the peaks are where the gradient is at a maximum. This is so because the energy function takes as input the gradient at boundary pixels, as can be seen from equation (19).

At step S95 it is determined if there are more candidates in C which have not been processed. If it is determined that there are more candidates in C then processing continues at step S85 where a new candidate c is selected. If it is determined that all candidates c in C have been processed then at step S96 the set of regions R is output.

Whilst it has been described above that the threshold is incremented by values of 0.1, it will be appreciated that other values of t are possible. For example increasing t by values smaller than 0.1 will give a larger number of areas Cₜ and therefore a smoother curve of the plot of values of E(t). The value of t may also be beneficially varied based upon the way in which normalization is carried out. Additionally, if it is determined that areas of an image that are possible blot haemorrhages may be larger or smaller than 3000 pixels, different values may be chosen for the threshold of step S88.

Some of the processing described below benefits from an accurate assessment of the properties of the background local to a particular candidate blot haemorrhage. First, it is necessary to determine a background region relevant to a particular blot haemorrhage. FIG. 16 shows the processing carried out to determine the relevant background region, which is carried out at step S55 of FIG. 11. At step S100 a candidate blot haemorrhage pixel c is selected for processing. At step S101, a region W centred on the pixel c of dimension 121×121 pixels is determined. A gradient is computed for each pixel in W at step S102. A h-minima transform is then applied to the determined gradients at step S103 to reduce the number of regions generated by subsequent application of a watershed transform as described below. A value of h for application of the h-minima transform is selected such that the number of minima remaining after application of the h-minima transform is between 20 and 60.

A watershed transform is then applied to the output of the h-minima transform at step S104. The watershed transform divides the area W into m sub-regions. A seed region for the next stage of region growing is then created by taking the union of all sub-regions which intersect the region r (determined at step S94 of FIG. 15) containing the pixel c at step S105.

At step S106 a check is carried out to determine whether the created region is sufficiently large. If this is the case, processing passes to step S107 where the created region is defined as the background surrounding r. Otherwise, processing continues at step S108 a further sub-region is added to the created region, the further sub-region being selected from sub-regions which are adjacent the created region, and being selected on the basis that its mean pixel value is most similar to that of the created region. Processing passes from step S108 to step S109 where a check is carried out to determine whether adding a further sub-region would result in too large a change in pixel mean or standard deviation. This might be caused if a vessel is included in an added sub-region. If this is the case, processing passes to step S107. Otherwise, processing returns to step S106.

The region created at step S107 represents a region of background retina surrounding the candidate blot haemorrhage and is denoted B. The region B is used to generate data indicative of the background of the candidate c.

A region identified as a candidate blot haemorrhage by the processing of FIG. 15 may lie on a vessel or on a crossing of a plurality of vessels. In such a case it may be that the region is not a blot haemorrhage. Identifying vessels that are close to an identified candidate blot haemorrhage is therefore desirable. Processing to identify vessels will now be described with reference to FIG. 17, and this processing is carried out at step S56 of FIG. 11.

Referring to FIG. 17, at step S115 a region r in the set of candidate regions R identified by the processing of FIG. 15 that has not previously been processed is selected. At step S116 an area S surrounding the selected region r of the input image is selected. The region r that has been determined to be a candidate blot haemorrhage is removed from the area S for the purposes of further processing. At step S117 a counter variable q is set to the value 5 and at step S118 the area S of the image A is tangentially shifted by q pixels. At step S119 the minimum of: S shifted by q pixels and; the inverse of S shifted by q pixels in the opposite direction; is determined according to equation (20) for all pixels so as to generate an image M_{τq}.

M_{τq}=min(τ_{q}(S)−τ_{-q}(S)) (20)

At step S120 it is determined if q has the value 11, which value acts as an upper bound for the counter variable q. If it is determined that q has a value of less than 11 then at step S121 q is incremented and processing continues at step S118. If it is determined at step S120 that q is equal to 11 then it is determined that the image S has been tangentially shifted by q pixels for q in the range 5 to 11 and at step S122 an image V is created by taking the maximum at each pixel across the images M_{τq} for values of q in the range 5 to 11. At step S123 the image V is thresholded and skeletonised to produce a binary image containing chains of pixels. These chains are split wherever they form junctions so that each chain is a loop or a 2-ended segment. 2-ended segments having one end closer to c than about 0.05DD (13 pixels) and the other end further than about 0.15DD (35 pixels) from c are retained as candidate vessel segments at step S124, and this set is denoted U_{seg} with members u_{seg}. Checking that the ends of a segment satisfy these location constraints relative to c increases the chance that the segment is part of a vessel of which the candidate haemorrhage, c, is also a part. All other 2-ended segments and all loops are rejected.

Each candidate vessel segment u_{seg} is classified at step S125 as vessel or background according to the following features:
1) Mean width of the candidate vessel segment region;
2) Standard deviation of the width of the candidate vessel segment region;
3) Width of the haemorrhage candidate at an orientation perpendicular to the mean orientation of the candidate vessel segment;
4) The mean of the square of the gradient magnitude along the boundary of the candidate vessel segment region;
5) The mean brightness of the vessel relative to the brightness and variation in brightness in background region B. The background region B is the region of retina surrounding the haemorrhage candidate determined by the processing of FIG. 16;
6) The standard deviation of brightness of the vessel relative to the brightness and variation in brightness in background region B; and
7) The distance that the extrapolated vessel segment passes from the centre of the candidate haemorrhage.

Using a training set of candidate vessel segments classified as vessel or background by a human observer, a support vector machine is trained to classify test candidate vessel segments as either vessel or background based on the values evaluated for the above features. The support vector machine outputs a confidence that a candidate vessel is a vessel or background. For each candidate blot haemorrhage the maximum of these confidences is taken for all candidate vessel segments surrounding the candidate blot haemorrhage.

At step S126 it is determined if there are more regions r in R that have not been processed. If it is determined that there are more regions in R then processing continues at step S115.

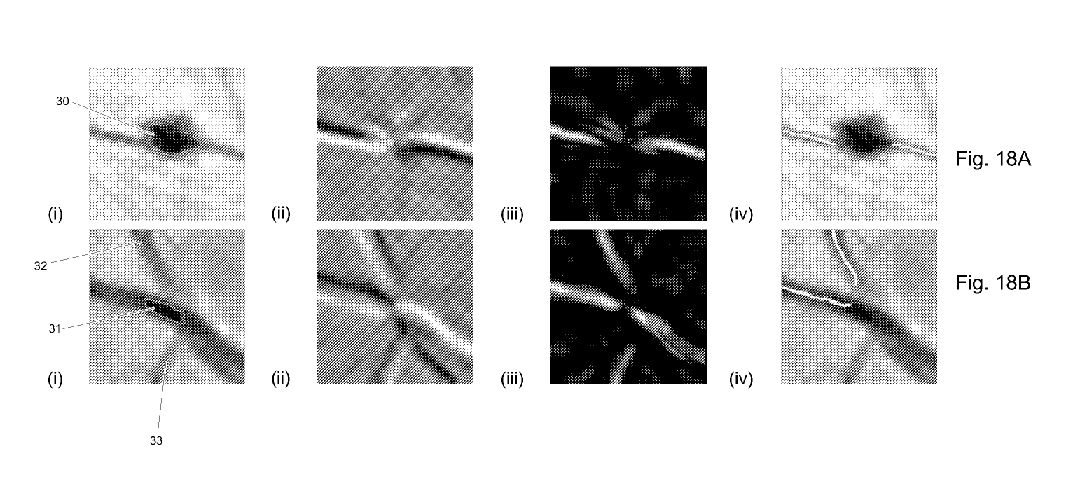

Referring now to FIGS. 18A and 18B, two example candidate regions generated using the processing of FIG. 15 are shown at four stages of the processing of FIG. 17.

FIG. 18A shows a blot haemorrhage 30 and FIG. 18B shows an area 31 identified as a candidate blot haemorrhage which is in fact the intersection of a number of vessels and is not a blot haemorrhage.

Images (i) in each of FIGS. 18A and 18B show candidate blot haemorrhages 30, 31 outlined in the original images. Candidate 31 of FIG. 18B lies at the join of vessels 32, 33 and therefore appears as a dark area similar to a blot haemorrhage.

Image (ii) in each of FIGS. 18A and 18B shows the result of taking a tangential gradient (step S118 of FIG. 17) and image (iii) in each of FIGS. 18A and 18B shows the image V created at step S122 of FIG. 17. The image (iv) of each of FIGS. 18A and 18B shows the original image with identified vessel segments shown as white lines.

The location of a candidate blot haemorrhage may be compared to detected vessel segments. Blot haemorrhages are often located on vessels as can be seen in FIG. 18A. Here it can be seen that a genuine blot haemorrhage lies on a vessel. In this case, a high vessel confidence could cause wrong classification of the blot haemorrhage unless another feature is evaluated that can distinguish between haemorrhages located on vessels such as in FIG. 18A and vessel crossings as shown in FIG. 18B, which may appear similar. Various parameters may be analysed as part of a process referred to as “discontinuity assessment” which allows candidate detections on vessels to be effectively distinguished as haemorrhage or not haemorrhage.

Discontinuity assessment is calculated for haemorrhage candidates which have one or more associated candidate vessel segments with a confidence, as calculated at step S125, greater than a threshold such as 0.5. Discontinuity assessment can be based upon three factors, calculated using the candidate vessel segments whose confidence, as calculated at step S125, is greater than aforementioned threshold. viz:

stronger(i)=z_{1.4}^{2.8}(E_{H}/E_{V}_{ᵢ}) (21)

wider=z_{1.4}^{2.3}(W_{C}/Wᵢₙ) (22)

junction=max(z₁₁₀¹⁴⁰(αᵢⱼ)) (23)

where:

$${z}_{L}^{U} ( x ) = \{ \begin{matrix}0 & if x \leq L \\ ( x - L ) / ( U - L ) & if L < x < U \\ 1 & if U \leq x\end{matrix} ,$$

is a z-function of a type used in fuzzy logic, E_{H} and E_{V} are “energies” of the blot haemorrhage candidate and vessel candidate respectively, meaning the mean squared gradient magnitude along the item boundary,
W_{H} is the mean width of the blot haemorrhage candidate,
Wᵢₙ is the diameter of a circle inscribed in the union of all vessel segments after they have been extrapolated towards the blot haemorrhage candidate until the vessel segments intersect each other;
αᵢⱼ is the intersection angle in degrees between two vessel segments, indexed i and j.

A value for discontinuity assessment can be determined using equation (24):

$$Discontinuity assessment = max ( min ( 1 - junction , {min}_{i} ( stronger ( i ) ) ) , wider ) \qquad ( 24 )$$

Expression 24 takes a value in the range 0 to 1 where 0 represents a low confidence of continuity, meaning the candidate haemorrhage is likely to be part of the detected vessel segment(s) and 1 represents a high confidence of a discontinuity meaning the candidate haemorrhage is likely to be a haemorrhage intersecting a vessel. is calculated to indicate the relation between the width and contrast of the candidate blot haemorrhage and the identified vessels surrounding the candidate blot haemorrhage.

The vessel confidence of FIG. 17 and discontinuity assessment based upon the vessel identification are passed to feature evaluation processing which will now be described with reference to FIG. 19.

Referring to FIG. 19, processing to evaluate the features of a candidate region is shown. The processing is intended to provide data indicating whether a candidate region is likely to be a blot haemorrhage or some other region, for example an intersection of vessels.

At step S130 a candidate region r in the candidate region set R is selected that has not previously been processed. At step S131 a feature vector vᵣ is determined for the selected candidate region. The feature vector vᵣ is a vector determined from a number of features as set out in Table 1 below.

TABLE 1

| Feature | Description |
|---|---|
| Area | The number of pixels in r |
| Width | Twice the mean distance of pixels in the skeletonisation (maximal |
| | morphological thinning) of r from the boundary of r |
| Normalised | Int(r)/Con(B) |
| Intensity | where: |
| | Int(r) is the mean intensity of A within r; and |
| | Con(B) is a measure of contrast in the background surrounding the |
| | candidate, given by the mean of medium frequency energy present |
| | within the area generated by the processing of FIG. 16. |
| Relative | Mean gradient magnitude of A along the boundary of r divided by |
| Energy | the minimum of A within r |
| Directionality | A histogram of gradient directions, θ, within r is created, with each |
| | pixel weighted by the local gradient magnitude. The histogram is |
| | convolved with a filter, 1 + cos(θ). During this convolution, the |
| | histogram is treated as periodic. Directionality is defined as the |
| | standard deviation of the resulting values divided by their mean. |
| Normalised | (Int(r) − Int(r3))/Con(B) where Int(r3) is the mean intensity in r after |
| Relative | morphological erosion by a circle of radius 3. |
| Intensity | |
| Vessel | Maximum of confidences of candidate vessel segments as |
| confidence | described with reference to FIG. 17, or zero if no candidate vessel |
| | segments were detected. |
| Discontinuity | Discontinuity assessment of candidate relative to vessel segments |
| Assessment | as described above or zero if no candidate vessel segments had a |
| | confidence higher than the threshold for inclusion within the discontinuity |
| | assessment evaluation. |

At step S132 a check is carried out to determine whether further candidate regions remain to be processed. If this is the case, processing returns to step S130. Otherwise processing passes to step S133 where a candidate vector is selected for processing. At step S134 a check is carried out to determine whether the candidate vector relates to a candidate region located within 100 pixels of the fovea, which is located using processing of the type described above with reference to FIG. 10.

If the check of step S134 is satisfied processing passes to step S135 where the processed vector is added to a set of vectors associated with candidates within 100 pixels of the located fovea. Otherwise, processing passes to step S136 where the processed vector is added to a set of vectors associated with candidates located more than 100 pixels from the located fovea. Processing passes from each of steps S135 and S136 to step S137 where a check is carried out to determine whether further candidates remain to be processed. If it is determined that further candidates remain to be processed, processing passes from step S137 back to step S133.

When all candidates have been processed in the manner described above, processing passes from step S137 to step S138 where vectors associated with candidate regions within 100 pixels of the fovea are processed to identify at most one processed region as the fovea. Candidates which are not identified as the fovea at step S138, together with candidates located more than 100 pixels from the expected fovea position, are then input to a support vector machine at step S139 to be classified as either a blot haemorrhage or background.

If the candidate region is within 100 pixels of the fovea, then the blot haemorrhage candidate may in fact be foveal darkening. If a classifier trained to output a confidence of being a fovea or of being a blot haemorrhage returns a higher result for fovea, for one or more haemorrhage candidates, then one of these candidates may be removed from a set of candidate blot haemorrhages. If there is a choice of candidates to be removed then the one nearest to the fovea location, as previously determined, should be removed. The blot haemorrhage candidates should then be classified as blot haemorrhage or background based on their feature vectors. The classification described above may be carried out by a support vector machine trained using a set of candidates generated from a set of training images in which each generated candidate has been hand classified as a fovea, haemorrhage or background by a human observer.

A training set of candidate blot haemorrhages are hand-classified as blot haemorrhage or background and the support vector machine is trained using these hand-classified candidates, such that on being presented with a particular feature vector, the support vector machine can effectively differentiate candidate areas which are blot haemorrhages from those which are not.

The preceding description has been concerned with the identification of blot haemorrhages. This identification is important, because it is known that the presence of blot haemorrhages on the retina is an indicator of diabetic retinopathy. As such, the techniques described above find application in automated processing of images for the detection of diabetic retinopathy. Blot haemorrhages can also be indicative of other disease conditions. As such, the techniques described above can be used to process images to identify patients suffering from other diseases of which blot haemorrhages are a symptom.

It is also known that exudates are indicative of disease states. As such, it is also useful to process retinal images to detect the presence of exudates.

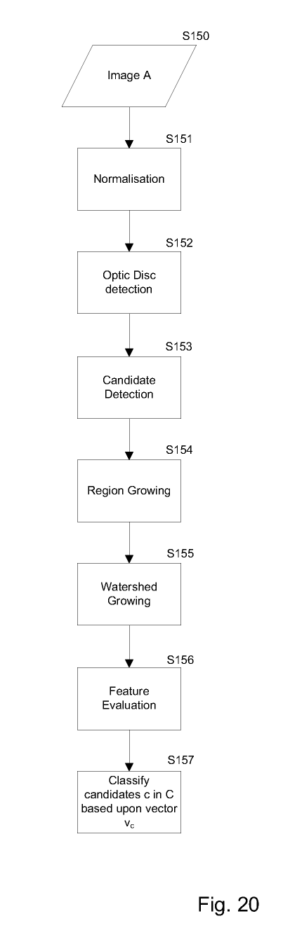

Referring now to FIG. 20, processing to identify exudates in an image is shown. At step S150 an image A corresponding to image 2 of FIG. 1 is input to the computer 5 of FIG. 1 for processing. At step S151 the image A is normalised in the same way as previously described with reference to FIG. 12. In colour images, exudates are usually most visible in the green colour plane of the image, and as such the processing of FIG. 12 carried out at step S151, and indeed most processing described below, if a colour image is being used, is carried out on the green colour plane.

At step S152 the optic disc is detected. The optic disc is a highly reflective region of the eye and it and the area surrounding it can therefore be falsely detected as exudate. Location of the optic disc is carried out using processing described above with reference to FIG. 8. A circular region of the image A of diameter 1.3DD centred on the optic disc centre is excluded from further analysis.

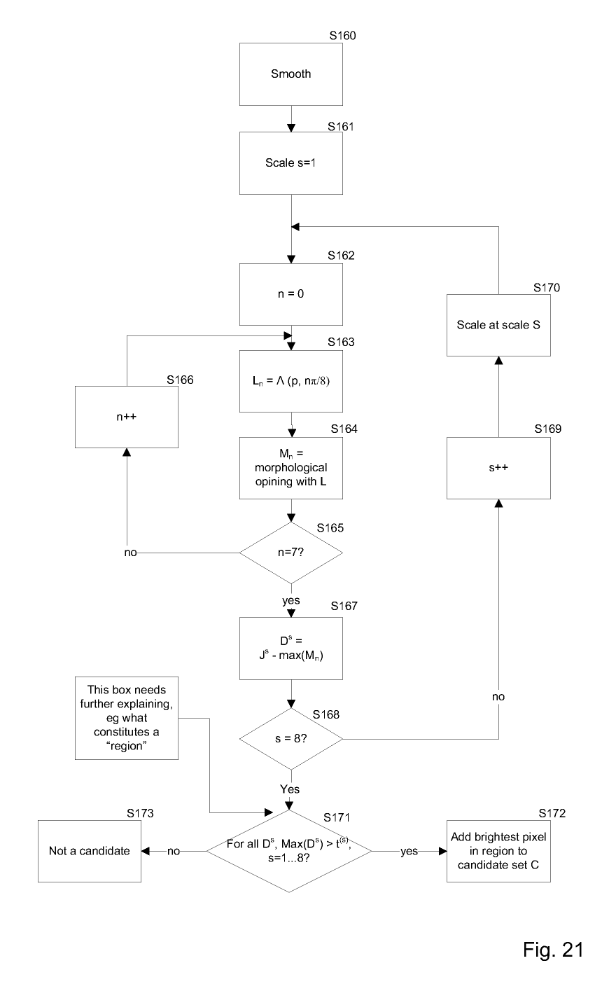

At step S153 the normalised image is processed to detect candidate exudates as described in further detail below with reference to FIG. 21. The processing of step S153 returns a single pixel in the image A for each detected candidate exudate. At step S154 the candidate exudates identified at step S153 are subjected to region growing to determine the region of the image A that is a possible exudate region corresponding to the identified candidate pixel. A suitable procedure for region growing is that described above with reference to FIG. 15.

At step S155 watershed region growing is applied as described above with reference to FIG. 16. Watershed region growing finds regions of retina that are not vessels or other lesions and these regions are processed to determine some of the features that are evaluated to generate a feature vector at step S156, the feature vector is created to include parameters indicative of a candidate exudate. The feature evaluation of step S156 is described in further detail below.

At step S157 each candidate exudate is processed to determine a confidence that the candidate is exudate, drusen or background. The determination is based upon the feature vector determined at step S156.

The detection of candidate exudates is now described with reference to FIG. 21. Some steps of the processing of FIG. 21 are very similar to equivalent steps in the processing of FIG. 13, and as such are only briefly described.

At step S160 the input image is smoothed in a process similar to that applied at step S65 of FIG. 13. At step S162 a counter variable n is initialised to a value of 0. At step S163 a linear structuring element is defined, using the function used at step S70 in the processing of FIG. 13, the function being shown in equation (18). At step S164 the linear structuring element defined at step S163 is used in a morphological opening operation of similar form to the operation carried out at step S71 of FIG. 13. At step S165 a check is carried out to determine whether the counter n has a value of 7. If this is not the case, processing passes from step S165 to step S166 where the value of n is incremented before processing continues at step S163. When it is determined at step S165 that the value of n is 7, processing passes to step S167.

The loop of steps S163 to S166 acts in a similar way to that of steps S70 to S73 of FIG. 13 to perform morphological opening with a series of eight structuring elements arranged at different orientations. Each image output from one of the opening operations includes only linear structures extending at a particular orientation.

At step S167 an image D^{s} is created by subtracting, for each pixel, the maximum value for that pixel across all images Mₙ. As explained with reference to step S74 of FIG. 13, this has the effect of removing linear structures from the image, though, in the case described here with reference to exudate detection, the linear structures removed are brighter than the surrounding retina.

Processing passes from step S167 to step S168 where a check is carried out to determine whether the value of s is equal to eight. If this is not the case, processing passes to step S169 where the value of s is incremented, before processing continues at step S170 where the image is scaled, relative to the original image, by a scaling factor based upon s, more particularly the scaling factor 2^{s-1} described with reference to FIG. 13. Processing passes from step S170 to step S162.

When it is determined at step S168 that the value of s is equal to 8, processing passes to step S171. At step S171, a check is carried out for a particular pixel to determine whether the maximum value for that pixel across all images D^{s} is greater than a threshold, determined as described below. If this is the case, a candidate region associated with the pixel is considered to be candidate exudate at step S172. Otherwise, the candidate region is not considered to be a candidate exudate at step S173.

The threshold applied at step S171 is selected firstly by fitting a gamma-distribution to the distribution of heights of the regional maxima in D^{s}. The threshold is placed at the point where the cumulative fitted distribution (its integral from −∞ to the point in question, with the integral of the whole distribution being 1) is 1-5/n, where n is the number of maxima in D^{s}. Only those maxima in D^{s} which are less than this threshold are retained.

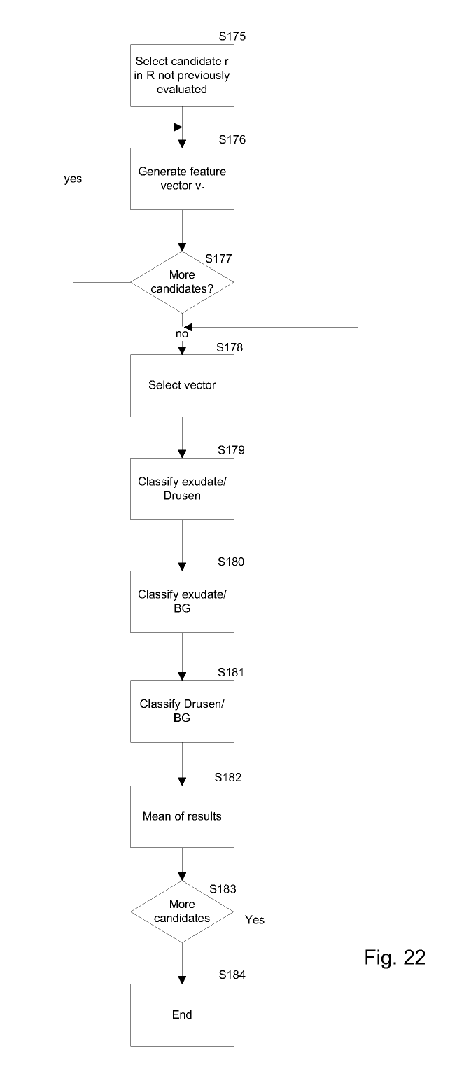

Referring to FIG. 22, processing to evaluate the features of a candidate region is shown. The processing is intended to provide data indicating whether a candidate region is likely to be exudate, drusen or background. Some steps of the processing of FIG. 22 are very similar to equivalent steps in the processing of FIG. 19, and as such are only briefly described.

At step S175 a candidate region r in the candidate region set R is selected that has not previously been processed. At step S176 a feature vector vᵣ is determined for the selected candidate region. The feature vector vᵣ is a vector determined from a number of features as set out in Table 2 below.

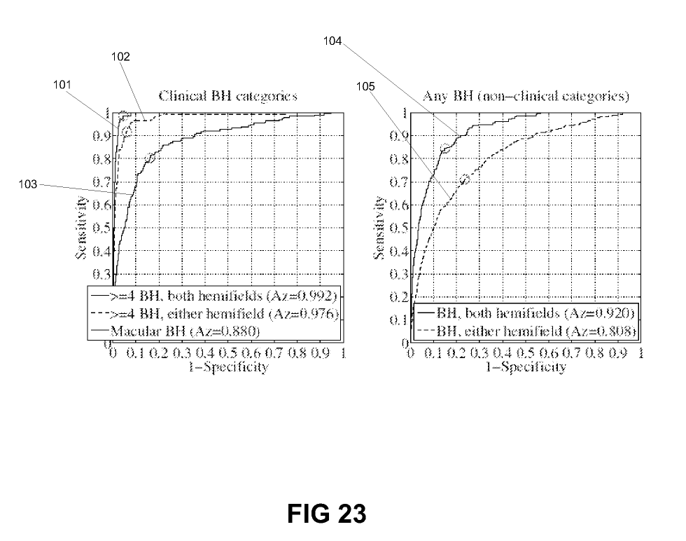

TABLE 2

| Feature | Description |
|---|---|
| Area | The number of pixels in r |
| distance from | The distance of the candidate from the nearest Microaneurysm. |
| MA | Microaneurysm detection is described below with reference to |
| | FIG. 23. |
| Normalised | (Lᵣ − L_{bg})/C_{bg} |
| Luminosity | where Lᵣ is the mean luminosity in the region r of the normalised |
| | image generated by the processing of FIG. 12; |
| | L_{bg} is the mean luminosity in the local background to the candidate |
| | determined within the area generated by the processing of FIG. 16; and |
| | C_{bg} is the mean contrast in the local background to the candidate |
| | determined within the same area. |
| Normalised sd | sd(Lᵣ)/C_{bg} |
| of Luminosity | where Lᵣ and C_{bg} are as described above. |
| Normalised | Calculated as the mean gradient magnitude of the region r along |
| Boundary | the boundary of r divided by C_{bg} |
| Gradient | |
| Spread | The spread of the region r evaluated as (\sqrt{Nᵣ}/d − 3\sqrt{π})/2 |
| | where Nᵣ is the number of pixels in r; and |
| | d is the mean distance of pixels in r from its boundary. The spread |
| | value has a minimum of 0 for a circle. |
| Standardised | A good quality well-exposed retinal image is chosen as a standard. |
| Colour | Histogram standardised planes are generated by applying a strictly |
| Features | increasing transformation to the red and green colour planes of I |
| | so that each result has a histogram which is similar to that of the |
| | corresponding plane of the standard image. The mean is taken of |
| | the standardised red and green planes over r. |

At step S177 a check is carried out to determine whether further candidate regions remain to be processed and if this is the case, processing returns to step S176. Otherwise processing passes to step S178 where a candidate vector is selected for processing.

A basic support vector machine is able to perform binary classification. To allow classification as either exudate, drusen or background, each of the classes are compared to each of the other classes using three one-against-one support vector machines and the mean is taken of the results. At step S179 the selected vector is processed by a support vector machine to classify the candidate as either exudate or drusen. At step S180 the selected vector is processed by a second support vector machine to classify the candidate as either exudate or background and at step S181 the selected vector is processed by a third support vector machine to classify the candidate as either drusen or background. Each support vector machine outputs a likelihood that a candidate is each of the two categories that the support vector machine is trained to assess. The likelihood for both categories sums to 1. At step S181 the mean of the likelihoods output from the three support vector machines for each class is taken. It will be appreciated that the resulting likelihoods calculated by taking the mean in the manner described above for the three categories will also sum to 1.

At step S182 a check is performed to determine if there are more candidates to be evaluated. If it is determined that there are more candidates to be evaluated then the processing of steps S178 to S182 is repeated. Otherwise at step S183 the processing of FIG. 22 ends.

A training set of candidate exudates are hand-classified as exudate, drusen or background and each support vector machine is trained upon these hand-classified candidates, such that on being presented with a particular feature vector, each support vector machine can effectively differentiate candidate areas which the particular support vector machine is intended to classify.

The processing described above to identify exudates in an image can be used to detect any suitable lesion generally classed as a bright spot in a retinal image. For example, the processing described above to identify exudates additionally provides an indication of the likelihood that a bright spot is drusen which can be useful for disease determination. Additionally, using automated supervised classification techniques, such as support vector machines as described above with reference to steps S179 to S181, that have been trained using suitable training sets of images, other bright spots such as cotton-wool spots may be identified.

Referring now to FIG. 23, processing carried out to detect microaneurysms is described. Detection of microaneurysms is required in order to evaluate the feature “distance from microaneurysm” shown in Table 2.

Candidate microaneurysms are located using a method similar to that of FIG. 13, although the input image is processed only at a single scale. That is, the processing of FIG. 13 is performed without the loop provided by step S74, and consequently without repeated scaling of the image as carried out at step S76. A set of candidate microaneurysms is created, however, as discussed with reference to steps S77 and S78 above. At step S77, the threshold used to determine whether a processed region is a candidate microaneurysm can suitably be selected to be 5 times the 95th percentile of pixels in D.

Each candidate microaneurysm, represented by a respective pixel, is subjected to region growing as described with reference to FIG. 15 above so as to create a candidate area for each microaneurysm. Watershed region growing, as described above with reference to FIG. 16 is also carried out to allow characteristics of the background of a candidate microaneurysm to be determined. More particularly, an estimate of background contrast: the standard deviation of pixels in the normalised image after high pass filtering within the region obtained from watershed retinal region growing can be determined and denoted BC.

A paraboloid is then fitted to the 2-dimensional region generated by the processing of FIG. 15. From the fitted paraboloid, the major- and minor-axis lengths are calculated as well as the eccentricity of the microaneurysm candidate.

Features used to determine whether a particular candidate microaneurysm is in fact a microaneurysm may include:
1. The number of peaks in energy function E, where the energy function has a form similar to equation (19) above;
2. Major and minor axis lengths determined as described above;
3. The sharpness of the fitted paraboloid (or alternatively the size of the fitted paraboloid at a constant depth relative to its apex can be used since this is inversely proportional to the sharpness of the paraboloid);
4. Depth (relative intensity) of the candidate microaneurysm using the original image and the background intensity estimated during normalisation;
5. Depth of the candidate microaneurysm using the normalised image and the fitted paraboloid divided by BC;
6. Energy of the candidate microaneurysm, i.e. the mean squared gradient magnitude around the candidate boundary divided by BC.
7. The depth of the candidate microaneurysm normalised by its size (depth divided by geometric mean of axis lengths) divided by BC.
8. The energy of the candidate microaneurysm normalised by the square root of its depth divided by BC.

Using a training set, a K-Nearest Neighbour (KNN)-classifier is used to classify candidates. A distance metric is evaluated between a feature vector to be tested and each of the feature vectors evaluated for a training set in which each of the associated candidate microaneurysms was hand-annotated as microaneurysm or not microaneurysm. The distance metric can be evaluated, for example as the sum of the squares of differences between the test and training features. A set is determined consisting of the K nearest, based on the distance metric, training candidate feature vectors to the test candidate feature vector. A candidate is considered to be a microaneurysm if L or more members of this set are true microaneurysms. For example, a candidate microaneurysm would be considered to be a true microaneurysm for L=5 and K=15 meaning 5 out of 15 nearest neighbours are true microaneurysms.

The method of detecting blot haemorrhages described above has been tested on 10,846 images. The images had been previously hand classified to identify blot haemorrhages present as follows: greater than or equal to four blot haemorrhages in both hemifields in 70 images; greater than or equal to four blot haemorrhages in either hemifield in 164 images; macular blot haemorrhages in 193 images; blot haemorrhages in both hemifields in 214 images; and blot haemorrhages in either hemifield in 763 images.

Receiver Operator Characteristic (ROC) curves for each of these categories are displayed in FIG. 23. A line 101 shows data obtained from images including four or more blot haemorrhages in both hemifields. A line 102 shows data obtained from images having four or more blot haemorrhages in either hemifield. A line 103 shows data obtained from images including macular blot haemorrhages. A line 104 shows data from includes including blot haemorrhages in both hemifields, while a line 105 shows data from images including blot haemorrhages in either hemifield.

Since the images with blot haemorrhages were drawn from a larger population than images without blot haemorrhages, data was rated to adjust to the prevalence of blot haemorrhages in the screened population of images, estimated to be 3.2%. High sensitivity and specificity are attained for detection of greater than or equal to 4 blot haemorrhages in both hemifields (98.6% and 95.5% respectively) and greater than or equal to four blot haemorrhages in either hemifield (91.6% and 93.9% respectively).

The method of detecting exudates as described above has been tested on a set of 13,219 images. Images had been previously classified manually for the presence of exudates and drusen as follows: 300 with exudates less than or equal to 2DD from the fovea, of which 199 had exudates less than or equal to 1 DD from the fovea; 842 images with drusen; 64 images with cotton-wool spots; 857 images with other detectable bright spots. 13.4% (1825) of the images with exudates contained one of the other categories of bright objects.

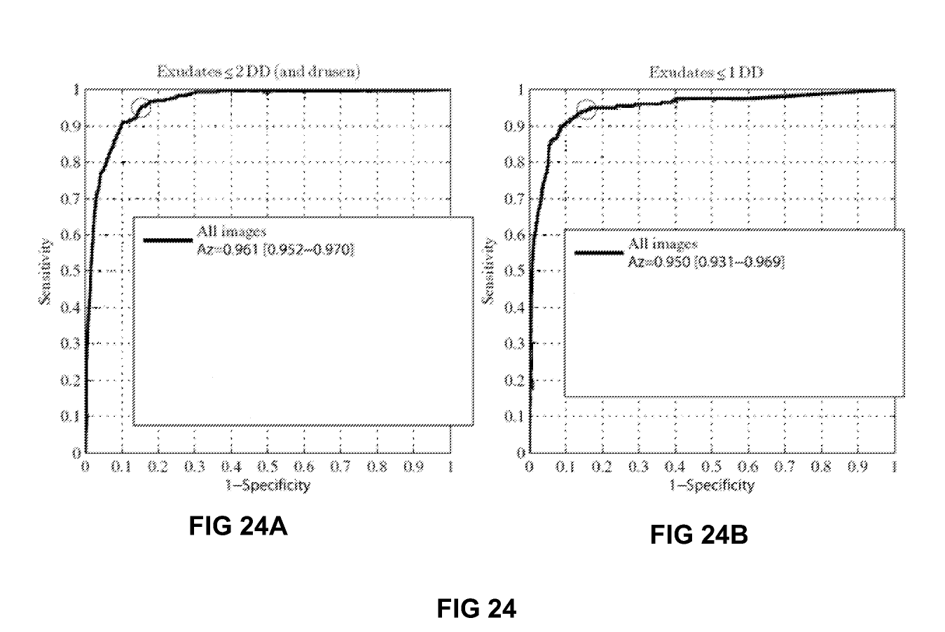

FIG. 24 shows ROC curves for exudate detection less than or equal to 2DD from the fovea) (FIG. 24A) and less than or equal to 1DD from the fovea (FIG. 24B). Images with referable or observable exudates (less than or equal to 2 DD from the fovea) were recognised at sensitivity 95.0% and specificity 84.6% and images with referable exudates (less than or equal to 1DD from the fovea) were recognised at sensitivity 94.5% and specificity 84.3%.

Although it is necessary to check the performance of automated by comparison with a human observer, it should be recognised that opinions confirming the disease content of retinal images can differ substantially. In studies comparing automated exudate detection with human expert detection, a retinal specialist attained 90% sensitivity and 98% specificity compared to a reference standard and a retinal specialist obtained 53% sensitivity and 99% specificity compared to a general ophthalmologist. The latter of these results is close to the ROC curve in FIG. 24.

The methods described above can be applied to retinal images to enable effective detection of blot haemorrhages and exudates. It is known, as indicated above, that the presence of blot haemorrhages and exudates in retinal images is indicative of various disease. Thus, the methods described herein can be effectively employed in the screening of retinal images by an automated, computer-based process. That is, a retinal image may be input to a computer arranged to carry out the methods described herein so as to detect the presence of blot haemorrhages and exudates within the image. Data indicating the occurrence of blot haemorrhages and exudates can then be further processed to automatically provide indications of relevant disease, in particular indications of diabetic retinopathy or age-related macular degeneration.

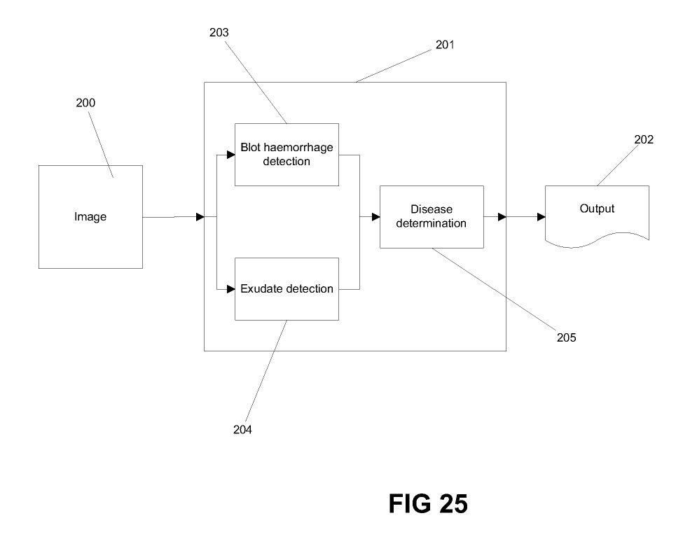

FIG. 25 is a schematic illustration of a suitable arrangement for providing indications of whether a particular image includes indicators of disease. An image 200 is input to a computer 201. The image 200 may be captured by a digital imaging device (e.g. a camera) and provided directly to the computer 201 by an appropriate connection. The computer 201 processes the image 200 and generates output data 202 (which may be displayed on a display screen, or provided in printed form in some embodiments). The computer 201 carries out various processing. In particular, a blot haemorrhage detection process 203 is arranged to process the image in the manner described above with reference to FIG. 11 to determine whether the image includes blot haemorrhages. An exudate detection process 204 is arranged to process the image in the manner described above with reference to FIG. 20 to identify exudates within the image 200. Data generated by the blot haemorrhage detection process 203 and the exudate detection process 204 is input to a disease determination process 205 which is arranged to generate the output data 202 discussed above.

The computer 201 can conveniently be a desktop computer of conventional type comprising a memory arranged to store the image 200, the blot haemorrhage detection process 203, the exudates detection process 204 and the disease determination process 205. The various processes can be executed by a suitable microprocessor provided by the computer 201. The computer 201 may further comprise input devices (e.g. a keyboard and mouse) and output devices (e.g. a display screen and printer).

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A method of processing a retinal image to detect an area representing a bright spot, the method comprising:
processing said image to remove linear structures and generate a processed image; and
detecting said area representing a bright spot in said processed image.

2. A method according to claim 1, wherein said bright spot is selected from the group consisting of: drusen, cotton-wool spot and exudate.

3. A method according to claim 1, further comprising:
processing said retinal image to locate an area representing the optic disc.

4. A method according to claim 3, further comprising excluding said area representing the optic disc from processing of said retinal image.

5. A method according to claim 1, further comprising processing said retinal image to generate a plurality of images, each of said plurality of images having been scaled by a respective associated scaling factor.

6. A method according to claim 5, wherein processing said image to remove linear structures and generate a processed image comprises processing each of said plurality of images to generate data indicating the presence of linear structures in each of said plurality of images.

7. A method according to claim 6, wherein generating data indicating the presence of linear structures in said plurality of images comprises, for each of said plurality of images:
performing a plurality of morphological opening operations with a plurality of linear structuring elements.

8. A method according to claim 6, wherein each of said linear structuring elements extends at a respective orientation.

9. A method according to claim 5, further comprising, for each of said plurality of images, removing linear structures from a respective image based upon said data indicating the presence of linear structures in said respective image to generate a respective D-image.

10. A method according to claim 9, further comprising combining said D-images to generate said processed image.

11. A method according to claim 10, wherein said processed image comprises a predetermined number of pixels, and each of said plurality of D-images comprise said predetermined number of pixels, and the method comprises, for each pixel of said single image:
selecting a value for the pixel in said processed image based upon values of that pixel in each of said plurality of D-images.

12. A method according to claim 11, further comprising performing a thresholding operation using a threshold on said processed image.

13. A method according to claim 12, wherein said threshold is based upon a characteristic of said processed image.

14. A method according to claim 12, further comprising identifying a plurality of connected regions of said processed image after performance of said thresholding operation.

15. A method according to claim 14, wherein the method further comprises:
selecting a single pixel from each of said connected regions, said single pixel being selected based upon a value of said single pixel relative to values of other pixels in a respective connected region.

16. A method according to claim 15, further comprising processing each of said single pixels to determine a desired region of said processed image based upon a respective single pixel.

17. A method according to claim 16, wherein determining a desired region for a respective pixel comprises:
processing said processed image with reference to a plurality of thresholds, each of said thresholds being based upon the value of said respective pixel;
selecting at least one of said plurality of thresholds; and
determining a respective desired region based upon the or each of said selected threshold.

18. A method according to claim 17, wherein selecting at least one of said plurality of thresholds comprises:
generating data for each of said plurality of thresholds, said data being based upon a property of a region defined based upon said threshold.

19. A method according to claim 17, wherein said property of a region defined based upon said threshold is based upon a gradient at a boundary of said region.

20. A method according to claim 17, wherein selecting at least one of said plurality of thresholds comprises selecting the or each threshold for which said property has a peak value.

21. A method according to claim 1, wherein processing said plurality of images to identify said area representing said bright spot comprises generating a plurality of data items, and inputting said plurality of data items into a classifier configured to determine whether an area of said image associated with said plurality of data items represents a bright spot.

22. A method according to claim 21, wherein said classifier generates output data indicating one or more confidences selected from the group consisting of: a confidence that said area represents drusen, a confidence that said area represents an exudate, a confidence that said area represents a background region, and a confidence that said area represents a bright spot.

23. A method according to claim 22, wherein said classifier comprises a plurality of sub-classifiers, each sub-classifier being arranged to generate data indicating a confidence that said area represents each of a pair of area types, each of said area types being selected from the group consisting of: drusen, exudate, background and cotton wool spot.

24. A method according to claim 22, wherein said classifier comprises a first sub-classifier arranged to generate data indicating a confidence that said area represents an exudate and a confidence that said area represents drusen, a second sub-classifier arranged to generate data indicating a confidence that said area represents an exudate and a confidence that said area represents a background region, and a third sub-classifier arranged to generate data indicating a confidence that said area represents drusen and a confidence that said area represents a background region.

25. A method according to claim 23, wherein said classifier computes a mean of confidence values produced by each of said plurality of sub-classifiers to generate said output data.

26. A computer readable medium carrying computer readable instructions arranged to cause a computer to process a retinal image to detect an area representing a bright spot, the processing comprising:
processing said image to remove linear structures and generate a processed image; and
detecting said area representing a bright spot in said processed image.

27. Apparatus for processing a retinal input image to identify an area representing a bright spot, the apparatus comprising:
a memory storing processor readable instructions; and
a processor arranged to read and execute instructions stored in said memory;
wherein said processor readable instructions comprise instructions arranged to cause the processor to:
process said image to remove linear structures and generate a processed image; and
detect said area representing a bright spot in said processed image.

28. A method of processing a retinal image to detect an area representing a bright spot, the method comprising:
processing said retinal input image to generate a plurality of images, each of said plurality of images having been scaled by a respective associated scaling factor, and each of said plurality of images having been subject to a morphological operation.

29. A method according to claim 28, wherein said bright spot is selected from the group consisting of: drusen, cotton-wool spot and exudate.

30. A method according to claim 28, wherein said morphological operation is arranged to detect at least one predetermined feature.

31. A method according to claim 28, wherein said morphological operation is a morphological opening operation.

32. A method of processing a retinal image to determine whether said image includes indicators of disease, the method comprising:
locating at least one area representing a bright spot by processing said image to remove linear structures and generate a processed image and detecting said area representing a bright spot in said processed image.

33. A method according to claim 32, wherein the disease is selected from the group consisting of diabetic retinopathy and age-related macular degeneration.

34. A method according to claim 32, wherein said bright spot is selected from the group consisting of: drusen, cotton-wool spot and exudate.

35. A method of processing a retinal image to detect an area representing an exudate, the method comprising:
processing said image to remove linear structures and generate a processed image; and
detecting said area representing an exudate in said processed image.

36. A method of processing a retinal image to detect an area representing an exudate, the method comprising:
processing said retinal input image to generate a plurality of images, each of said plurality of images having been scaled by a respective associated scaling factor, and each of said plurality of images having been subject to a morphological operation.

37. A method of processing a retinal image to determine whether said image includes indicators of disease, the method comprising:
locating at least one area representing a bright spot by processing said image to remove linear structures and generate a processed image and detecting said area representing a bright spot in said processed image.
